(19) United States
(12) Patent Application Publication
(10) Pub. No.: US 2016/0030910 A1
(43) Pub. Date: Feb. 4, 2016

(54) HIGH-THROUGHPUT PARTICLE PRODUCTION USING A PLASMA SYSTEM

(71) Applicant: SDCMATERIALS, INC., Tempe, AZ (US)

(72) Inventors: Maximillian A. BIBERGER, Scottsdale, AZ (US); David LEAMON, Gilbert, AZ (US); Frederick p. LAYMAN, Tempe, AZ (US); Paul LEFEVRE, Portland, OR (US)

(21) Appl. No.: 14/774,616

(22) PCT Filed: Mar. 12, 2014
(86) PCT No.: PCT/US14/24933

§ 371 Date: Sep. 10, 2015

Related U.S. Application Data
(60) Provisional application No. 61/784,299, filed on Mar. 14, 2013.
(60) Provisional application No. 61/684,350, filed on Aug. 17, 2012.
(60) Provisional application No. 61/885,988, filed on Oct. 2, 2013.
(60) Provisional application No. 61/885,990, filed on Oct. 2, 2013.
(60) Provisional application No. 61/885,996, filed on Oct. 2, 2013.
(60) Provisional application No. 61/885,998, filed on Oct. 2, 2013.

(51) Int. Cl. B01J 19/08; H05H 1/42

(52) U.S. Cl. CPC B01J 19/088; H05H 1/42; B01J 2219/0809; B01J 2219/0869; B01J 2219/0801; B01J 2219/0871; B01J 2219/0879; B01J 2219/0894

(57) ABSTRACT

The present disclosure relates to a nanoparticle production system and methods of using the system. The nanoparticle production system includes a plasma gun including a male electrode, a female electrodes and a working gas supply configured to deliver a working gas in a vortexing helical flow direction across a plasma generation region. The system also includes a continuous feed system, a quench chamber, a cooling conduit that includes a laminar flow disruptor, a system overpressure module, and a conditioning fluid purification and recirculation system.

### CROSS-REFERENCE TO RELATED APPLICATIONS

This application claims priority benefit of U.S. Provisional Patent Application No. 61/784,299, filed Mar. 14, 2013; of U.S. Provisional Patent Application No. 61/864,350, filed Aug. 9, 2013; of U.S. Provisional Patent Application No. 61/885,988, filed Oct. 2, 2013; of U.S. Provisional Patent Application No. 61/885,990, filed Oct. 2, 2013; of U.S. Provisional Patent Application No. 61/885,996, filed Oct. 2, 2013; and of U.S. Provisional Patent Application No. 61/885,998, filed Oct. 2, 2013. The entire contents of those applications are hereby incorporated by reference herein.

### FIELD OF THE INVENTION

The present invention relates to systems and methods for providing high-throughput particle production using a plasma.

### BACKGROUND OF THE INVENTION

Nanoparticles can be formed using a plasma production system in which one or more feed materials are fed into a plasma gun that generates plasma using a working gas. The plasma vaporizes the feed materials, which is then condensed to form nanoparticles in a quenching reaction. The nanoparticles can then be collected and used for a variety of industrial applications.

Typical plasma-based particle production systems have been limited in their ability to remain in continuous operation with consistent material throughput and are typically based on lab-scale and pilot plant scale designs. These systems are typically severely limited in the mass/volume throughput. This makes the industrial scale production of consistent quality and sized nanoparticles inefficient.

### SUMMARY OF THE INVENTION

Described are nanoparticle production systems, devices used within such systems and methods of using the systems and devices. The nanoparticle production systems may include a plasma gun including a male electrode, a female electrode and a working gas supply configured to deliver a working gas in a vortexing helical flow direction across a plasma generation region. The systems may also include one or more of, a continuous feed system, a quench chamber, a cooling conduit that includes a laminar flow disruptor, a system overpressure module, and a conditioning fluid purification and recirculation system. Systems incorporating various combinations of these features are also envisaged and in some cases systems having combinations of these features provide distinct technical advantages, such as improvement in the length of time for which the system may be operated continuously, improvement in the quality or quantity of particles that are produced, and/or improvement in the efficiency of the production system. Methods of manufacturing nanoparticles using these systems also form part of the present proposals.

In some embodiments, a nanoparticle production system includes a plasma gun; and a continuous feed systems configured to feed material into the plasma gun at a rate of at least 9 grams/minute.

In any of the embodiments, the continuous feed system may be configured to feed material to the plasma gun for at least 336 hours without clogging. In any of the embodiments, the continuous feed system may include multiple material feed supply channels to supply feed material to the plasma gun. In any of the embodiments, the continuous feed system may include a reciprocating member to continually clear out a material feed supply channel during operation of the nanoparticle production system. In any of the embodiments, the reciprocating member may reciprocate at a rate of at least 2 times per second.

In any of the embodiments, the continuous feed system may include a pulsing gas jet to continually clear out a material feed supply channel during operation of the nanoparticle production system.

In any of the embodiments, the plasma gun may include a male electrode, a female electrode and a working gas supply configured to deliver a working gas in a vortexing helical flow direction across a plasma generation region formed between the male electrode and the female electrode.

In any of the embodiments, the working gas supply may include an injection ring positioned before the plasma generation region to create the vortexing helical flow direction. In any of the embodiments, the injection ring may include a plurality of injection ports. In any of the embodiments, the injection ports may be disposed in an annular formation around the male electrode. In any of the embodiments, the injection ports may be angled toward the male electrode.

In any of the embodiments, the injection ports may be angled away from the male electrode. In any of the embodiments, the nano-production system may be able to operate for at least 336 hrs without replacement of the male electrode or female electrode.

In any of the embodiments, the nanoparticle production system may further include a quench chamber positioned after the plasma gun and including at least one reaction mixture input and at least one conditioning fluid input. In any of the embodiments, the quench chamber may have a frusto-conical shape and may be configured to create turbulence with a Reynolds number of greater than 1000 during operation.

Any of the embodiments may further include a cooling conduit configured to conduct nanoparticles entrained in a conditioning fluid flow from the quench chamber to a collector. In any of the embodiments, the cooling conduit may include a laminar flow disruptor. In any of the embodiments, the laminar flow disruptor may include blades, baffles, a helical screw, ridges, or bumps. In any of the embodiments, the particle production system may be configured to operate continuously for at least 6 hrs without clogging occurring in the cooling conduit. Any of the embodiments may further include a cooling conduit configured to conduct nanoparticles entrained in a conditioning fluid flow from the quench chamber to a collector. In any of the embodiments, the cooling conduit may include a laminar flow disruptor. In any of the embodiments, the laminar flow disruptor may include blades, baffles, a helical screw, ridges, or bumps. In any of the embodiments, the particle production system may be configured to operate continuously for at least 336 hrs without clogging occurring in the cooling conduit.

Any of the embodiments, may further include a system overpressure module that maintains a pressure in the system above a measured ambient pressure. In any of the embodiments, the pressure in the system may be maintained at a pressure of at least 1 inch of water above the measured ambient pressure. Any of the embodiments, may further include a system overpressure module that maintains a pressure in the system above a measured ambient pressure.

Any of the embodiments, may further include a conditioning fluid purification and recirculation system. In any of the embodiments, at least 80% of the conditioning fluid introduced into the nanoparticle production system may be purified and recirculated.

In some embodiments a nanoparticle production system includes a plasma gun including a male electrode, a female electrodes and a working gas supply configured to deliver a working gas in a vortexing helical flow direction across a plasma generation region formed between the male electrode and the female electrode; a continuous feed systems configured to feed material into the plasma gun at a rate of at least 9 grams/minute; a quench chamber positioned after the plasma gun and including at least one reaction mixture input and at least one conditioning fluid input; a cooling conduit configured to conduct nanoparticles entrained in a conditioning fluid flow from the quench chamber to a collector, wherein the cooling conduit comprises a laminar flow disruptor; a system overpressure module that maintains a pressure in the system above a measured ambient pressure; and a conditioning fluid purification and recirculation system.

### BRIEF DESCRIPTION OF THE DRAWINGS

FIG. 1 is a schematic illustration of one embodiment of a plasma system useful for generating nanoparticles;

FIG. 2A is a schematic illustration of one embodiment of a plasma gun with a material feed port;

FIG. 2B is a schematic illustration of one embodiment of a plasma gun with a faceplate and cooling ring;

FIG. 2C is a schematic illustration of an alternative embodiment of a plasma gun with a plasma gun faceplate and cooling ring;

FIG. 2D is a schematic illustration of a tangential view the embodiment of a plasma gun with a plasma gun faceplate and cooling ring illustrated in FIG. 2B;

FIG. 2E is a schematic illustration of one embodiment of a plasma gun with a reduced plasma gun faceplate, a cooling ring, and a wider and heat-resistant conductive metal lined plasma channel;

FIG. 2F is a schematic illustration of a tangential view the embodiment of a plasma gun with a reduced plasma gun faceplate, a cooling ring, and a wider and heat-resistant conductive metal lined plasma channel illustrated in FIG. 2E;

FIG. 3A is a schematic illustration of one embodiment of a plasma gun useful for a high-throughput particle production system with a working gas injection ring and alternate material injection ports allowing for continuous material feed;

FIG. 3B is a schematic illustration of one embodiment of a plasma gun useful for a high-throughput particle production system with a working gas injection ring and a reciprocating plunger device allowing for continuous material feed;

FIG. 3C is a schematic illustration of one embodiment of a plasma gun useful for a high-throughput particle production system with a working gas injection ring and a pulsing air jet system allowing for continuous material feed;

FIG. 3D is a schematic illustration of one embodiment of a plasma gun useful for a high-throughput particle production system with a reduced plasma gun faceplate, a cooling ring, a wider and heat-resistant conductive metal lined plasma channel a working gas injection ring and alternate material injection ports allowing for continuous material feed;

FIG. 3E is a schematic illustration of one embodiment of a plasma gun useful for a high-throughput particle production system with a reduced plasma gun faceplate, a cooling ring, a wider and heat-resistant conductive metal lined plasma channel a working gas injection ring and a reciprocating plunger device allowing for continuous material feed;

FIG. 3F is a schematic illustration of one embodiment of a plasma gun useful for a high-throughput particle production system with a reduced plasma gun faceplate, a cooling ring, a wider and heat-resistant conductive metal lined plasma channel a working gas injection ring and a pulsing air jet system allowing for continuous material feed;

FIG. 4A is a schematic illustration of one embodiment of a high-throughput particle production system with an ultra-turbulent quenching chamber and turbulence inducing jets;

FIG. 4B is a schematic illustration of an alternative embodiment of a high-throughput particle production system with an ultra-turbulent quenching chamber and turbulence inducing jets where the turbulence inducing jets are interconnected in a ring structure;

FIG. 5 is a detailed schematic illustration of the interconnected turbulence inducing jets in a ring structure illustrated in FIG. 4B;

FIG. 6A is a schematic illustration of one embodiment of a high-throughput particle production system with a laminar flow disruptor;

FIG. 6B is a schematic illustration of an alternative embodiment of a high-throughput particle production system with a laminar flow disruptor;

FIG. 6C is a schematic illustration of an alternative embodiment of a high-throughput particle production system with a laminar flow disruptor using air jets;

FIG. 6D is a schematic illustration of an alternative embodiment of a high-throughput particle production system with a laminar flow disruptor using rotating axially arranged rods;

FIG. 7 is a tangential view schematic illustration of one embodiment of the laminar flow disruptor using rotating axially arranged rods illustrated in FIG. 6D;

FIG. 8 is a schematic illustration of one embodiment of a high-throughput particle production system with a gas delivery system with constant overpressure;

FIG. 9 is a schematic illustration of one embodiment of a high-throughput particle production system with a conditioning fluid purification and recirculation system; and

FIG. 10 is a schematic illustration of one embodiment of a high-throughput particle production system with a conditioning fluid purification and recirculation system integrated into a system overpressure module of a gas delivery system with constant overpressure.

FIG. 11 is a schematic illustration of one embodiment of a high-throughput particle production system with a filter back pulse system useful for unclogging a filter element in a collection device.

### DETAILED DESCRIPTION OF THE INVENTION

A typical nanoparticle production system can generate nanoparticles by feeding material into a plasma stream, thereby vaporizing the material, and allowing the produced reactive plasma mixture to cool and coagulate into nano-particles and composite or “nano-on-nano” particles. The particles can then be collected for use in a variety of applications. Preferred nano-particles and “nano-on-nano” particles are described in U.S. application Ser. No. 13/801,726, the description of which is hereby incorporated by reference in its entirety.

This disclosure refers to both particles and powders. These two terms are equivalent, except for the caveat that a singular “powder” refers to a collection of particles. The present invention can apply to a wide variety of powders and particles. The terms “nano-particle” and “nano-sized particle” are generally understood by those of ordinary skill in the art to encompass a particle on the order of nanometers in diameter, typically between about 0.5 nm to 500 nm, about 1 nm to 500 nm, about 1 nm to 100 nm, or about 1 nm to 50 nm. Preferably, the nano-particles have an average grain size less than 250 nanometers and an aspect ratio between one and one million. In some embodiments, the nano-particles have an average grain size of about 50 nm or less, about 30 nm or less, or about 20 nm or less. In additional embodiments, the nano-particles have an average diameter of about 50 nm or less, about 30 nm or less, or about 20 nm or less. The aspect ratio of the particles, defined as the longest dimension of the particle divided by the shortest dimension of the particle, is preferably between one and one hundred, more preferably between one and ten, yet more preferably between one and two. “Grain size” is measured using the ASTM (American Society for Testing and Materials) standard (see ASTM E112-10). When calculating a diameter of a particle, the average of its longest and shortest dimension is taken; thus, the diameter of an ovoid particle with long axis 20 nm and short axis 10 nm would be 15 nm. The average diameter of a population of particles is the average of diameters of the individual particles, and can be measured by various techniques known to those of skill in the art.

In additional embodiments, the nano-particles have a grain size of about 50 nm or less, about 30 nm or less, or about 20 nm or less. In additional embodiments, the nano-particles have a diameter of about 50 nm or less, about 30 nm or less, or about 20 nm or less.

A composite nanoparticle is formed by the bonding of two different nano particles. This bonding may occur during the quench phase of the of a nano-phase production method. For example, a catalyst may include a catalytic nanoparticle attached to a support nanoparticle to form a “nano-on-nano” composite nanoparticle. Multiple nano-on-nano particles may then be bonded to a micron-sized carrier particle to form a composite micro/nanoparticle, that is, a micro-particle bearing composite nanoparticles.

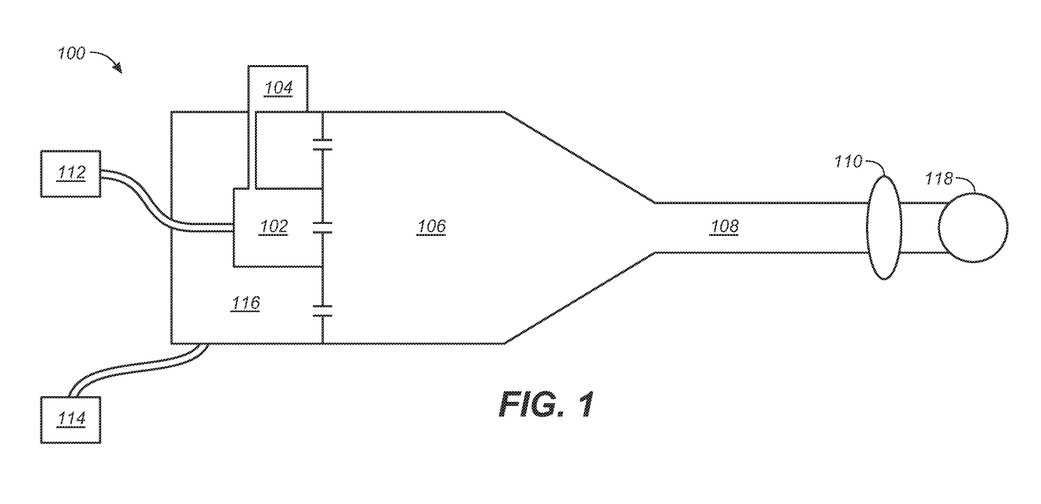

As shown in FIG. 1, a plasma system useful for generating nanoparticles 100 includes a plasma gun 102, a material input feed system 104, a quench chamber 106 fluidly connected to a cooling conduit 108, and an output collection system 110. A working gas 112 flows through the plasma gun 102 to generate plasma, while a conditioning fluid 114 flows into a gun box 116, and then into the quenching chamber 106. Negative pressure can be applied to the collection end of the plasma production system using a vacuum or blower 118 to provide directional flow of the conditioning fluid and material output.

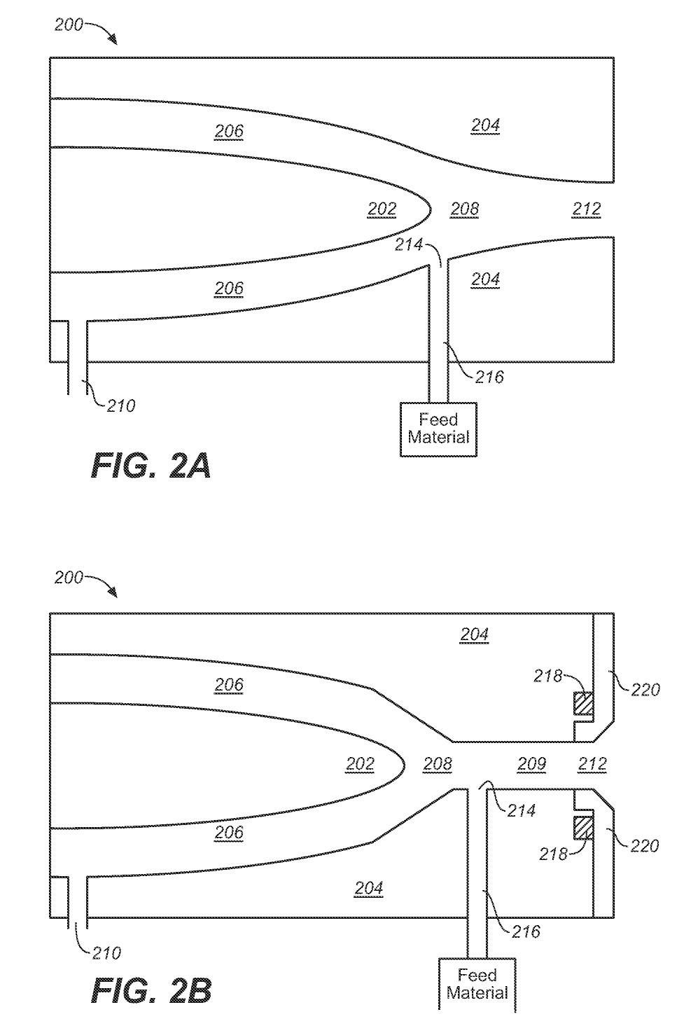

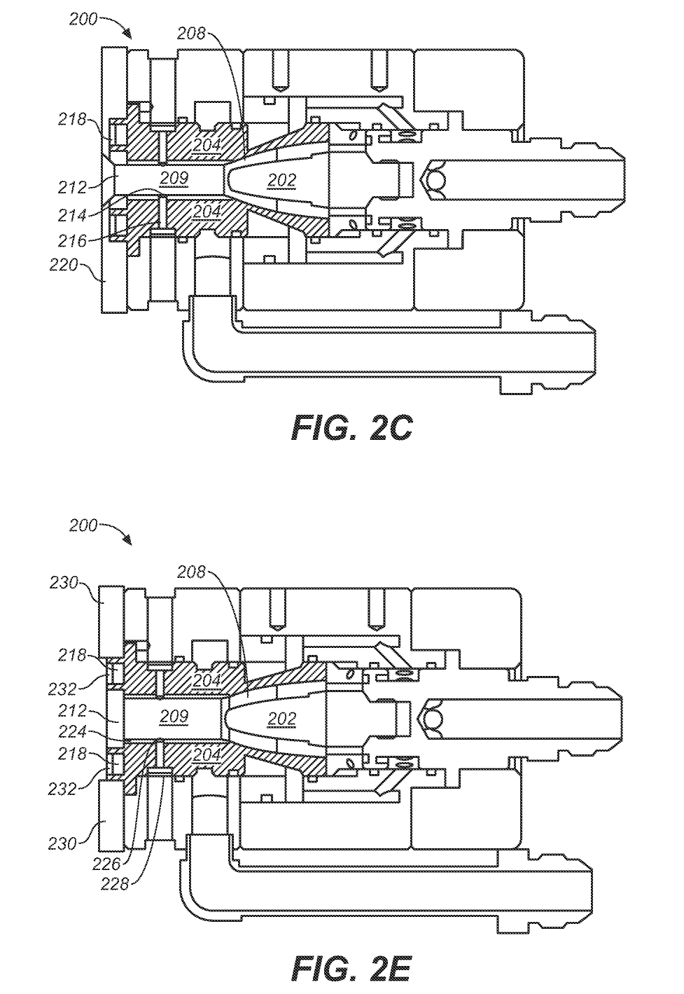

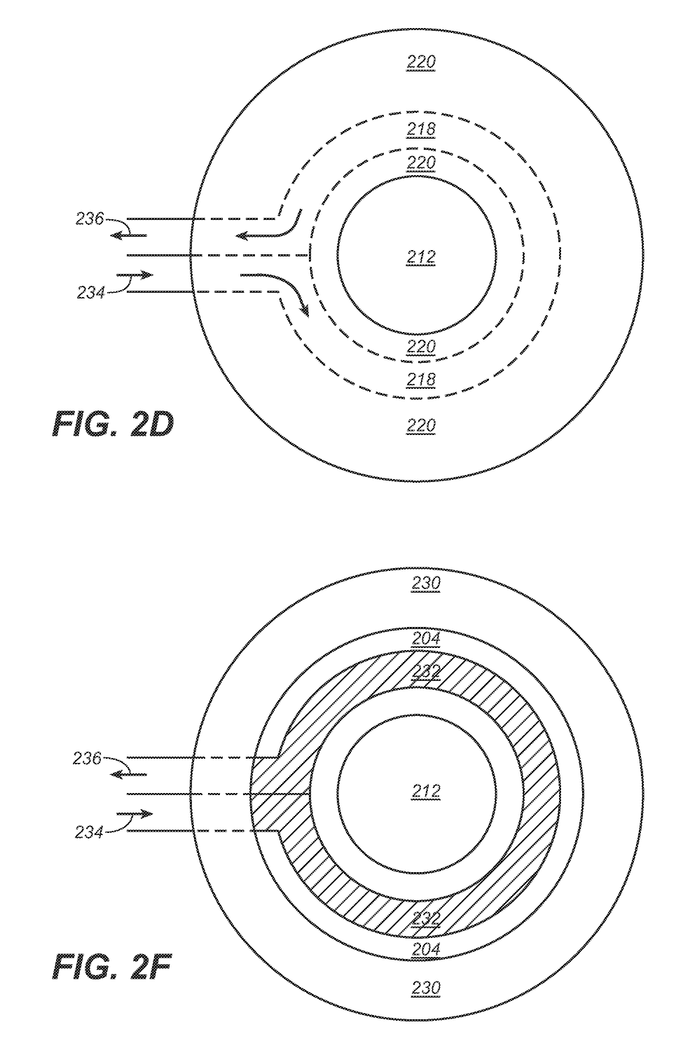

FIG. 2A illustrates an embodiment of a plasma gun that can be used for particle production. A plasma gun 200 includes a male electrode 202 and a female electrode 204 with an internal chamber formed between the male electrode 202 and the female electrode 204. The internal chamber comprises an entry region 206 at one end and a plasma region 208 at an opposite end. In some embodiments, the entry region 206 has a cylindrical shape, while the plasma region 208 has a frusto-conical shape. The internal chamber is configured to have a working gas introduced into its entry region 206 and then flown into the plasma region 208. In some embodiments, the working gas is an inert gas, for example argon. In some embodiments, hydrogen or other gasses may be added to argon to reduce nanoparticle oxidation.

For example, in some embodiments, the working gas is a mixture of argon and hydrogen at a ratio of 30:1 to 3:1. In some embodiments, the working gas is a mixture of argon and hydrogen at 20:1 ratio. In some embodiments, the working gas is a mixture of argon and hydrogen at a 12:1 ratio. In some embodiments, the working gas is a mixture of argon and hydrogen at a 8:1 ratio. In some embodiments, the working gas is a mixture of argon and hydrogen at a 5:1 ratio. A gas inlet 210 is configured to supply the working gas to the entry region 206. During operation of the high-throughput plasma-based particle production system, the working gas flows through the entry region 206, to the plasma region 208, and out of the outlet 212. A power supply is connected to the male electrode 202 and the female electrode 204, and delivers power through the plasma gun 200 by passing current across the gap between the male electrode 202 and the female electrode 204 in the plasma region 208. The current arcing across the gap in the plasma region 208 energizes the working gas and forms a plasma stream, which flows out of the outlet 212.

As vaporized material is expelled from the plasma gun, the radiant heat can damage parts of the plasma gun. As illustrated in FIG. 2B-D, a cooling ring 218 can be positioned in the female electrode 204 and annularly disposed about the outlet 212 to prevent or slow heat induced damage to the female electrode 204 and other plasma gun 200 components. A cooling fluid, for example, water, can be recirculated through the cooling ring 218 to disperse a portion of the heat generated by the plasma during operation of the system. A faceplate 220 can be joined to the cooling ring. The faceplate 220 is disposed on the exterior face of the plasma gun 200 and may be used to hold the female electrode 204 in place and seal the cooling ring 218. In FIG. 2D, dashed lines represent the cooling ring 218, which is covered by the faceplate 220. Cooling fluid is circulated throughout the cooling ring 218 by entering through the cooling ring entry port 234 and exiting through the cooling ring exit port 236. Cooling fluid may be recirculated using a pump, or otherwise disposed. As plasma is generated in the plasma region 208, travels through a cylindrical channel 209 within the female electrode 204, and exits through the outlet, radiant heat generated by the plasma can be dispelled by the cooling fluid.

A material injection port 214 can be disposed on the female electrode 204 linking a material feed channel 216 to the cylindrical channel 209. Feed material can be fed into the cylindrical channel 209 through the material feed channel 216 and vaporized by the plasma before flowing out of the outlet 212 and into the quenching chamber. Particle nucleation and surface growth occurs within the cylindrical channel 209 immediately following energy delivery, and the particles continue to grow in size within the quenching chamber. Particles cool within the quenching chamber and cooling conduit before being collected by a collection system. After particle collection, the conditioning fluid is generally vented into the ambient or otherwise disposed.

For cost-effective large-scale production of nanoparticles, high material throughput and continuous operation of the nanoparticle production system is preferred. Previous plasma-based nanoparticle production systems were troubled by frequent shutdowns in order to clear clogged channels and replace worn parts. For example, the heat of the plasma gun would frequently cause feed material to melt and clog material feed channels, which could only be unclogged if the system was shut down. Plasma gun electrodes became pitted during operation, and the system would need to be shut down to replace these parts. The plasma gun faceplate can melt during continuous operation, causing cooling fluid to leak form the cooling ring, which can result in the system being shut down to replace the faceplate. Particles would build up along the walls of the cooling conduit, and the system would need to be shut down to clean the cooling conduit. Furthermore, nanoparticle size was inconsistent and difficult to control because of variations in system pressure and material flow rates. For example, if pressure within the quenching chamber dropped below ambient pressure, impurities could leak into the system and degrade the quality of the produced nanoparticles. Additionally, uncontrolled cooling and material flow rates in the quenching chamber led to inconsistently sized particles. Another concern was that disposal of spent conditioning fluid was not cost-effective for large-scale production. Such hurdles hamper the average throughput speed, cost-effectiveness, and consistency of particles produced by plasma based nanoparticle production systems.

The described systems, apparatuses, and methods reduce system outages, produce higher volume and more consistent throughputs, and create more consistent nanoparticles using a high-throughput particle production system. Such high-throughput systems, apparatuses, and methods create continuous and consistent flow by reducing stoppages and variation within the system. A high-throughput particle production system can remain operational for at least 6 hours, at least 12 hours, at least 24 hours, at least 48 hours, at least 72 hours (3 days), at least 336 hours (14 days), at least 672 hours (28 days), or at least 1344 hours (56 days), with a material throughput of at least 9 grams per minute, preferably 30 grams per minute, and more preferably 60 grams per minute.

Particle production system throughput relies on constant material flow. Slow or inconsistent material flow causes a system back up, which results in an uneven particle size distribution. The described systems, apparatuses, and methods provide for continuous operation of an efficient high-throughput particle production system using continuous input feed material flow, avoidance of significant wear on the plasma gun electrodes, a controlled method of quickly cooling particles in the quenching chamber, a mechanism to avoid newly formed nanoparticles from sticking to the walls of the cooling conduit, constant but minimal system overpressure relative to the ambient pressure, and/or recirculation of used conditioning fluid.

### Reduction of Wear of Plasma Gun Faceplate

Extended operation of a typical plasma based nanoparticle production systems may result in melting and distortion of the plasma gun faceplate, and a system shutdown may be required to replace it. While the plasma gun is in operation, hot vaporized material and newly generated nanoparticles are expelled through the plasma gun outlet and into the quenching chamber. As the particles pass through the plasma gun outlet, significant heat is dispersed to the faceplate, which can cause it to melt and/or distort. Since proper shape of the faceplate is used to form or seal the cooling ring, distortion of the faceplate may result in leakage of cooling fluid. Since the cooling ring is used to control the temperature of the system, any melting or distortion of the faceplate may result in a system shutdown and a loss of productivity.

It has been found that increasing the diameter of the faceplate opening such that the faceplate's exposure to the hot plasma gun vapor outlet is minimized prevents melting and distortion of the faceplate. The cooling ring can then be sealed with a heat resistant material independent of the faceplate. The temperature of the faceplate is preferably kept below 900° C., below 450° C., or below 100° C., during continuous operation of the plasma gun for more than 24 hours, more than 48 hours, more than 72, hours, more than 160 hours, more than 336 hours, more than 672 hours, or more than 1344 hours. FIGS. 2E-F illustrate one embodiment of the modified plasma gun faceplate 230 and independently sealed cooling ring 218. The modified plasma gun faceplate 230 is disposed such that it can retain the female electrode 204 in the correct position but does not get so close to the plasma gun outlet 212 that it becomes melted or distorted during continuous system operation. The independently sealed cooling ring 218 is sealed using a heat resistant plug 232. The heat resistant plug may be made from any heat resistant material, for example, stainless steel, titanium, ceramic, or the like.

This configuration of the high-throughput particle production system results in a less frequent need to replace the plasma gun faceplate and allows for continuous use of the high-throughput particle production system. The described systems allow the particle production system to operate continuously at a flow rate of at least 9grams/minute, of at least 30 grams/minute, or of at least 60 grams/minute for at least 6 hours, at least 12 hours, at least 24 hours, at least 48 hours, at least 72 hours (3 days), at least 336 hours (14 days), at least 672 hours (28 days), or at least 1344 hours (56 days), without replacement of the faceplate.

### Continuous Material Feed System

In a nanoparticle production system, input material, which may be in powder, pellet, rod, or other form, is fed into the plasma gun near the plasma channel via a material feed channel. Material entering the plasma channel is vaporized by the plasma stream and expelled into the quenching chamber. However, in most particle production systems using a plasma gun, the heat of the plasma melts the powder particles fed into the plasma gun before they reach the plasma channel. It has been found that melted or partially melted feed material results in agglomeration of the feed material and a clogging of the material feed channel. Consequently, operation of the plasma gun must be stopped until it is cleaned, resulting in a loss of productivity and the inability to run the system continuously for long periods of time.

In a high-throughput system, a constant flow of material is fed into the plasma channel to allow continuous system operation using a continuous material feed system, avoiding interruptions of input feed material flow. The described systems provide a device that automatically clears any feed material in the feed channel or allows for the feed channel to be cleared while continuous operation of the plasma gun continues. In one embodiment, interruption of input feed material flow into the plasma gun due to melting of the feed material in the feed channel can be prevented or reduced by employing alternate material injection ports that can be alternately cleaned or used in operation. In addition or alternatively, a reciprocating plunger device can be attached to the plasma gun to push input feed material through the material injection port into the plasma gun, avoiding significant feed material agglomeration and clogging of the feed channel. In addition or alternatively, a pulsing air jet system can be used to blast clearing fluid into the material feed system, to clear material and prevent clogging of the channel.

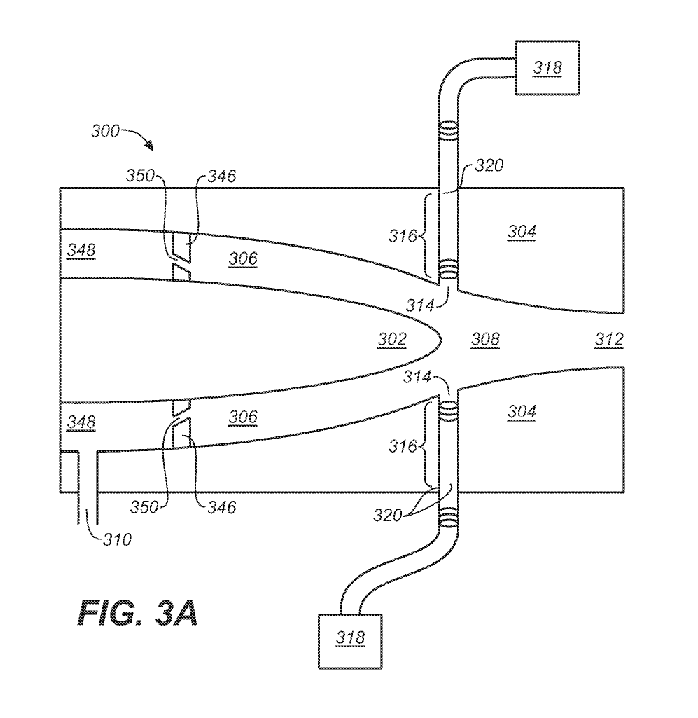

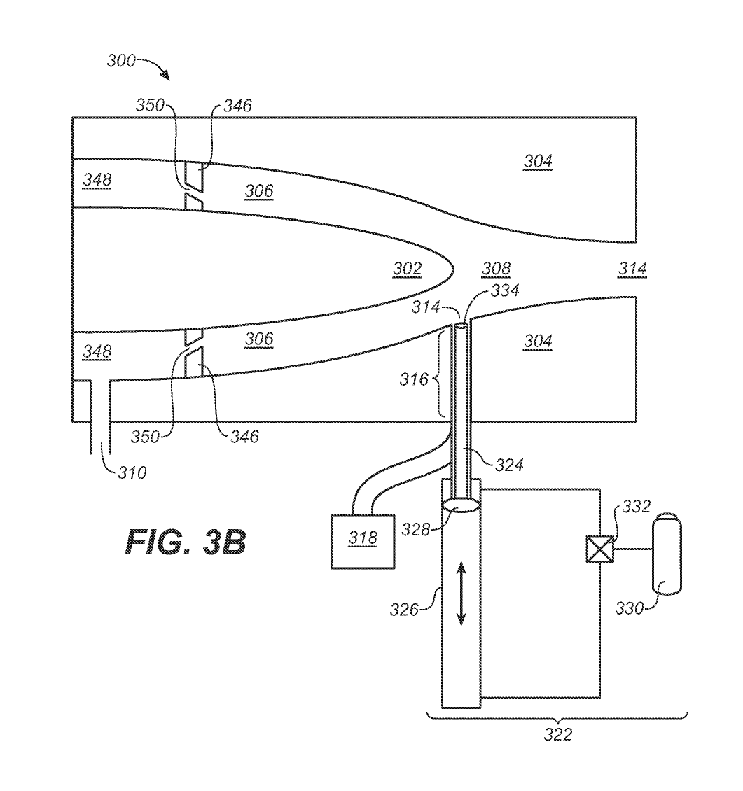

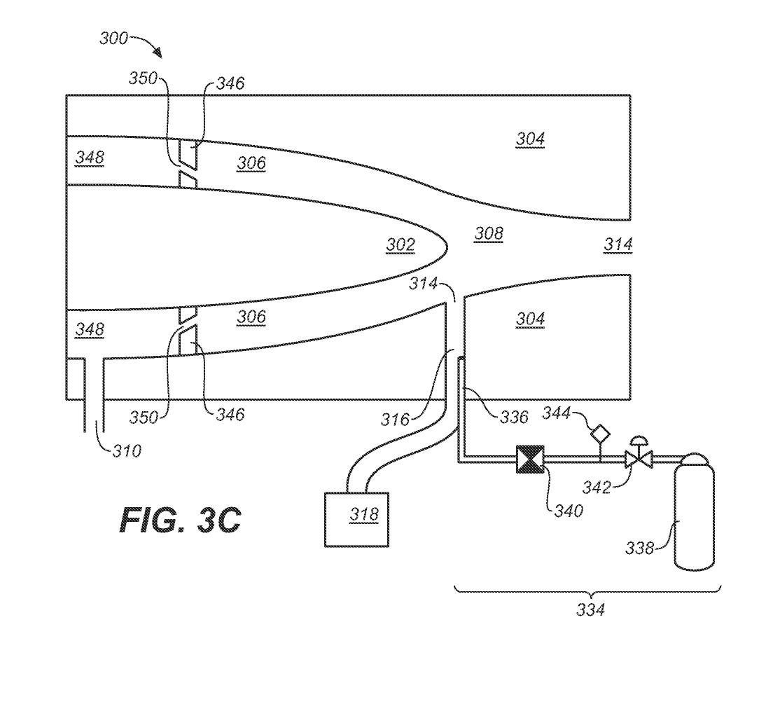

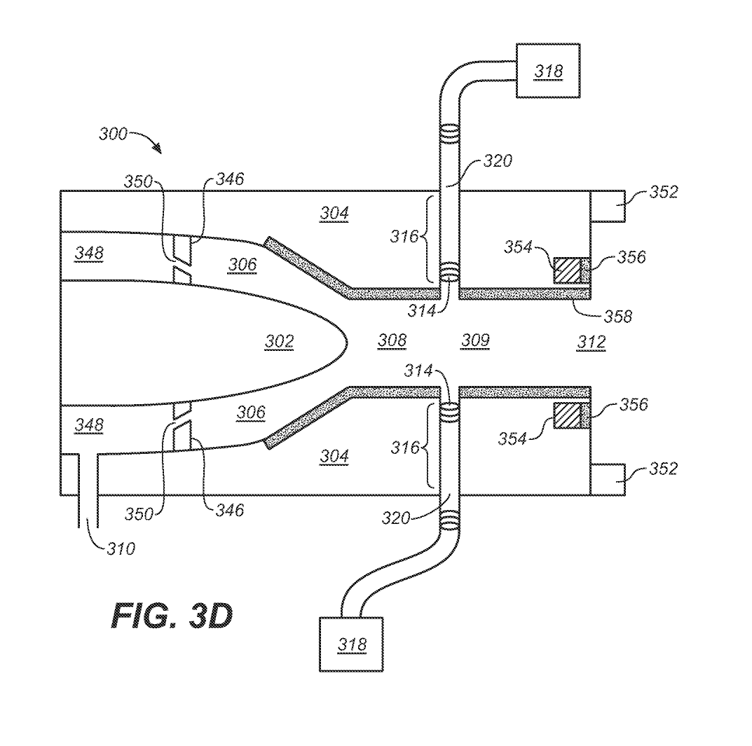

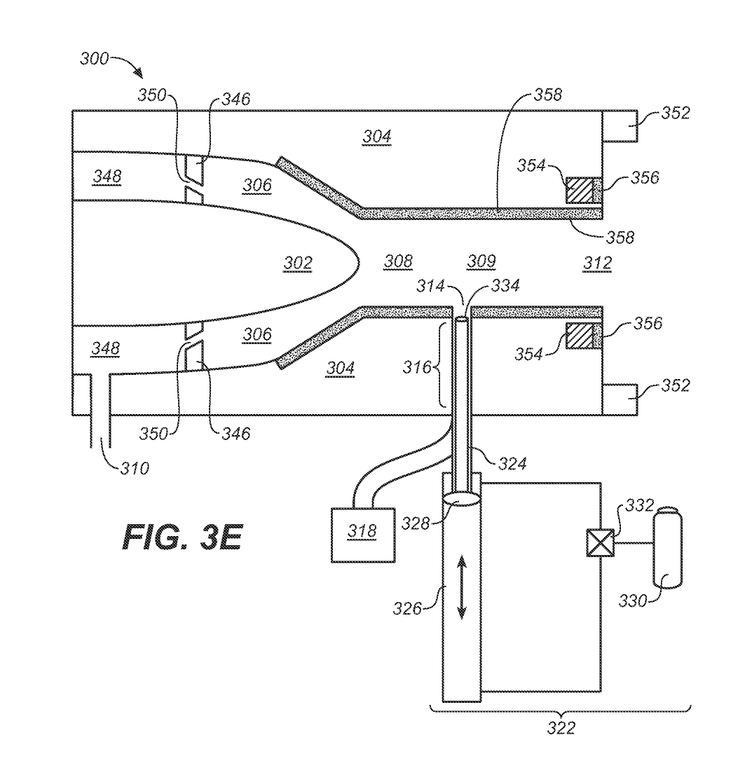

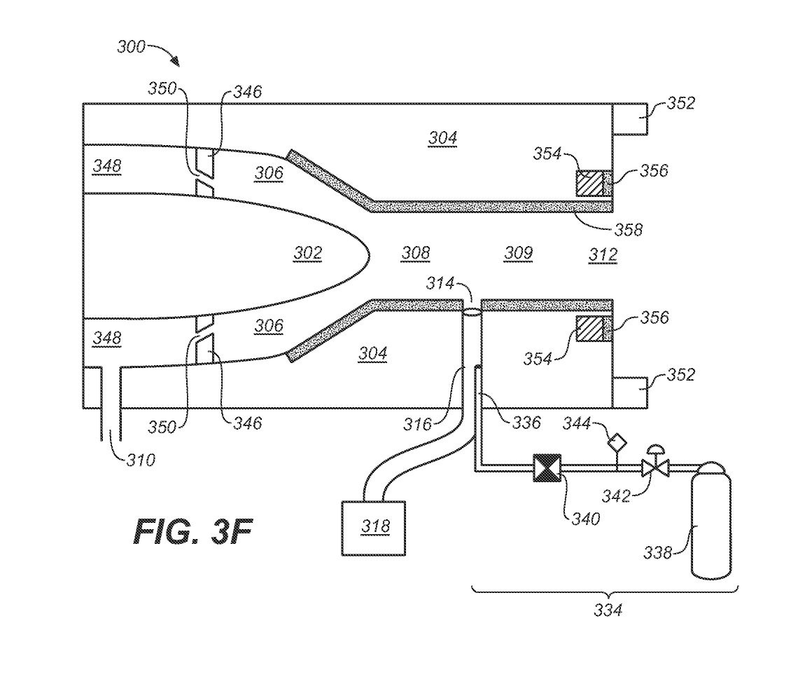

FIGS. 3A-C illustrate some embodiments of the continuous material feed system. As illustrated in FIGS. 3A-C, the plasma gun 300 includes one or more material injection ports 314 configured to introduce feed material into the internal chamber at a location within the plasma region 308. One or more material supply channels 316 can be provided in the female electrode 304 to connect a material supply 318 to a material injection port 314. In some embodiments, multiple material injection ports 314 and material supply channels 316 are disposed in an annular formation around the internal chamber. In some embodiments, a single material injection port 314 and material supply channel 316 is used. In some embodiments, two or more material injection ports 314 and material supply channels 316 are used. In some embodiments, the material injection ports 314 and material supply channels 316 are configured to introduce the feed material into the internal chamber at a location disposed closer to where the working gas is introduced into the entry region 306 than to where the plasma stream is formed. In some embodiments, the material injection ports 314 and material supply channels 316 are configured to introduce the feed material into the internal chamber at a location disposed closer to a plasma gun outlet 312. The diameters of the material injection ports 314 in a continuous material feed system can range from about 1 millimeters to about 20 millimeters. Wider material injection ports 314 have a decreased frequency of clogging relative to narrower material injection ports. Preferably, the minimum diameters of the material injection ports 314 are at least 3 millimeters to allow continuous material flow and continued system operation.

FIG. 3A illustrates one embodiment of the continuous material feed system using alternate material injection ports. Such embodiments include two or more material injection ports 314 and material supply channels 316. Within each material supply channel 316 is disposed a removable material supply tube 320 connecting the material supply 318 to the material injection port 314. Optionally, the removable material supply tube 320 can be temporarily fixed in place using a threaded connector or clasping mechanism. During operation of the high-throughput particle production system, one or more material supply channels 316 can be active and one or more material supply channels 316 can be inactive. While a material supply channel 316 is inactive, no feed material flows through that material supply channel 316 into the plasma gun. While a material supply channel 316 is active, feed material flows from the material supply 318, through the removable material supply tube 320 and material supply channel 316, out the material injection port 314, and into the plasma gun. During extended continuous use of the high-throughput particle production system, the radiating heat of the hot plasma may cause the feed material to partially melt, causing agglomeration of the feed material and clogging of the removable material supply tube 320. When it is detected that the removable material supply tube 320 is beginning to clog, the inactive material supply channels 316 may become activated and the active material supply channels 316 may become inactivated. While the material supply channel 316 is inactive, the removable material supply tube 320 may be removed from the material supply channel 316 and unclogged, cleaned, or replaced. The removable material supply tube 320 can then be refitted into the material supply channel 316 and activated when necessary or otherwise desired. This switching of activation states of the material supply channels 316 ensures that at least one material supply channel 316 remains in the active state during operation of the high-throughput particle production system, and ensures continuous material feed flow.

FIG. 3B illustrates one embodiment of the continuous material feed system using a reciprocating plunger device 322. The reciprocating plunger device 322 includes a plunger 324, a plunger housing 326, and a control mechanism. The plunger 324 is disposed such that the plunger 324 extends through the material supply channel 316 when in the extended position as illustrated in FIG. 3B. The plunger 324 can also retract into the plunger housing 326 as controlled by the control mechanism. The control mechanism may be any mechanism allowing the plunger 324 to reciprocate between an extended and retracted position. In some embodiments, the control mechanism may be a crankshaft or hydraulic control system. In the embodiment illustrated in FIG. 3B, the control mechanism is a gas powered piston 328 activated by applying gas from a gas source 330 to a 4-way direct-acting solenoid valve 332. The direct acting spring-return solenoid valve 332 applies gas alternatively to the top and bottom of the plunger housing 326 thereby activating the piston 328 and allowing the plunger 324 to reciprocate. In some embodiments, the gas used is argon. In some embodiments, the plunger reciprocates at a rate of at least 2 times per second, more preferably at least 6 times per second, or at least 8 times per second. In some embodiments the plunger is ceramic to avoid decay and contamination due to the heat of the nearby plasma. In other embodiments, the plunger is made out of or lined with tungsten.

During operation of the particle production system, feed material is allowed to flow from the material supply 318 and over a plunger head 334 when the plunger 324 is in the retracted position. The reciprocating plunger control mechanism extends the plunger 324 through the material supply channel 316 terminus, delivering powder to the internal chamber via the material injection port 314. The insertion of the plunger 324 through the material supply channel 316 alleviates clogging of the material supply channel 316 and material injection port 314 caused by agglomeration of the feed material. The plunger 324 then reciprocates to the initial retracted position, restarting the cycle. Upon reciprocation of the plunger 324 to its initial retracted position, feed material can again flow from the material supply 318 over the plunger head 334. The plunger 324 can repeat this motion at regular intervals, allowing a constant flow of feed material into the internal chamber of the plasma gun 300.

FIG. 3C illustrates one embodiment of the continuous material feed system using a pulsing gas jet system 334. In a pulsing gas jet system 334, a gas jet 336 is disposed within the material supply channel 316 directed towards the injection supply port 314. A gas supply 338 supplies a gas, preferably argon, to the gas jet 336. The flow of the gas may be controlled by a 2-way direct-acting solenoid valve 340, allowing pulsed gas to be released from the gas jet 336 into the material supply channel 316. A pressure regulator 342 and a pressure relief valve 344 can be disposed between the gas supply 338 and 2-way direct-acting solenoid valve 340 to regulate the pressure of the released gas. The high pressured pulsed gas can clear any agglomerated feed material in the material supply channel 316 preventing clogging during operation of the high-throughput particle production system.

Providing a continuous material feed system to a nanoparticle production system ensures the system does not need to be shut down to clear agglomerated feed material clogging the material supply channel. This allows for continued flow of feed material into a high-throughput particle production system allowing for extended system operation and throughput. The described systems allow the particle production system to operate continuously at a flow rate of feed material of at least 9 grams/minute, of at least 30 grams/minute, or of at least 60 grams/minute for at least 6 hours, at least 12 hours, at least 24 hours, at least 48 hours, at least 72 hours (3 days), at least 336 hours (14 days), at least 672 hours (28 days), or at least 1344 hours (56 days).

### Reduction of Uneven Wear of Plasma Gun Electrodes

It has been found that extended operation of a typical plasma based nanoparticle production systems results in excessive pitting and erosion of the plasma gun electrodes, necessitating a system shutdown to replace these worn parts. While the plasma gun is in operation, working gas is introduced into an entry region and proceeds to flow through the plasma channel formed between the male electrode and female electrode. A current applied to the working gas between the male and female electrodes energizes the gas into a plasma stream resulting in a stationary plasma arc forms between the electrodes. Uneven heat distribution caused by the stationary plasma arc causes uneven wear to the plasma gun electrodes. In particular, the electrodes become pitted during operation. Uneven electrode pitting and wear results in inconsistent flow of the working gas within the plasma region, as some portion of the working gas becomes trapped in or slowed by the electrode pits or other wear and is unable to flow evenly through the plasma channel. Inconsistent flow during particle formation is undesirable as it results in uncontrolled and uneven particle coalescence. Uneven pitting therefore leads to replacement of the electrodes, which necessitates a system shutdown and a loss of productivity.

It has been found that uneven wear of the plasma gun electrodes can be avoided or slowed by applying a non-linear bulk flow direction, preferably a substantially vortexing helical flow of the working gas across the electrodes. The substantially vortexing helical flow of the working gas prevents a stationary plasma arc by evenly distributing the working gas. This also prevents pitting of the electrode and the resulting disruption to system operation, allowing continuous use of the high-throughput particle production system. In one embodiment, a working gas injection ring placed within the plasma gun prior to the plasma region can provide the necessary vortex. The working gas injection ring preferably contains one or more ports annularly positioned around the male electrode, generating even gas flow distribution.

FIGS. 3A, 3B, and 3C each illustrate a plasma gun 300 with a working gas injection ring 346. The working gas injection ring 346 is disposed in a channel formed by the male electrode 302 and the female electrode 304, separating the entry region 306 from a plenum chamber 348. The plenum chamber 348 preferably accepts working gas from a gas inlet 310 and supplies the working gas to the entry region 306 of the channel through an injection ring 364. Working gas is preferably supplied at a higher pressure in the plenum chamber 348 than in the entry region 306 to avoid backflow through the working gas injection ring 346. In some embodiments, the injection ring 346 is ceramic. Preferably, the injection ring 346 comprises one or more injection ports 350 through which the working gas is supplied to the entry region 306. In some embodiments, multiple injection ports 350 are disposed in an annular formation around the male electrode 302 and are preferably uniformly spaced apart. In a one embodiment, the injection ports 350 are configured to supply the working gas to the entry region 306, and ultimately to the plasma region 308, in a substantially vortexing helical pattern. In some embodiments, the injection ports 350 are angled towards the male electrode 302 in order to induce the substantially vortexing helical pattern. In some embodiments, the injection ports 350 are angled away from the male electrode 302 in order to induce the substantially vortexing helical pattern. In order to ensure that the gas comes out of all nozzles, the pressure in the plenum chamber 348 is higher than the pressure downstream of the plenum chamber 348 and gas injection ring 346. As a result of the working gas substantially vortexing in a helical pattern due to the placement of the injection ring 346, the plasma arc generated in the plasma region 308 moves around to various locations on the male electrode 302 and female electrode 304, thereby substantially avoiding pitting or uneven wear of the male electrode 302 and female electrode 304.

Electrode wear may also be reduced by utilizing a heat resistant conductive metal to produce the male electrode 302 or female electrode 304. Alternatively, all or part of the male electrode 302 or female electrode 304 may be lined with a heat resistant conductive metal such as tungsten, niobium, molybdenum, tantalum, or rhenium. In some embodiments, the heat resistant conductive metal is tungsten. The male electrode 302 and the female electrode 304 need not be made from or lined with the same heat resistant conductive material. In some embodiments, only the male electrode 302 is lined with a heat resistant conductive metal. In another embodiment, only the female electrode 304 is lined with a heat resistant conductive metal. In some embodiments, only the cylindrical channel 309 along the female electrode 304 is lined with a heat resistant conductive metal. Heat resistant conductive metal allows the electrodes to withstand the high temperatures produced by the plasma for a longer period of time thereby reducing wear compared to conductive metals more frequently used in plasma gun electrodes, such as brass or copper.

This configuration of the high-throughput particle production system results in a less frequent need to replace the plasma gun electrodes and allows for continuous use of the high-throughput particle production system. The described systems allow the particle production system to operate continuously at a flow rate of at least 9 grams/minute, of at least 30 grams/minute, or of at least 60 grams/minute for at least 6 hours, at least 12 hours, at least 24 hours, at least 48 hours, at least 72 hours (3 days), at least 336 hours (14 days), at least 672 hours (28 days), or at least 1344 hours (56 days), without replacement of the electrodes.

### Narrow Particle Size Distribution Through Increased Dwell Time

Particle nucleation and surface growth occurs immediately following energy delivery and material vaporization within the cylindrical channel 309 of the plasma gun. The dwell time in which the particles continue to coagulate and coalesce continues form the time following vaporization until the particles are expelled into the quenching chamber and sufficiently cooled. A longer dwell time results in a narrower particle size distribution, which is desirable in the production of nanoparticles. The dwell time could be increased by decreasing the working gas flow rate through the plasma gun, but this would result in an overall decrease in material throughput, which is undesirable in a high-throughput nanoparticle production system.

It has been found that widening the cylindrical channel 309 within the female electrode 304 can sufficiently increase the dwell time during particle formation without affecting overall material throughput to produce nanoparticles with a narrow particle distribution. In some embodiments, the diameter of the cylindrical channel 309 is from about 3 millimeters to about 20 millimeters. Preferably, the diameter of the cylindrical channel 309 is at least 4 millimeters. The average dwell time of particles in the plasma gun is at least 3 ms, at least 10 ms, or at least 40 ms.

The described system allow the particle production system to operate continuously at a flow rate of at least 9 grams/minute, of at least 30 grams/minute, or of at least 60 grams/minute for at least 6 hours, at least 12 hours, at least 24 hours, at least 48 hours, at least 72 hours (3 days), at least 336 hours (14 days), at least 672 hours (28 days), or at least 1344 hours (56 days), while producing nanoparticles with a sufficiently narrow size distribution.

### Ultra-Turbulent Quenching Chamber

Following ejection from the plasma gun into the quenching chamber, the particles continue to grow due to coagulation and coalescence of the vaporized material during the cooling process. This cooling process occurs within the quenching chamber. In some instances, maintaining a reactive mixture at too high a temperature for too long of a time can lead to overly agglomerated particles in the final product. Typical methods of cooling the newly formed nanoparticles include mixing the hot reactive mixture with a conditioning fluid in a frusto-conical quenching chamber. The frusto-conical shape of the quenching chamber allows increased turbulence of the conditioning fluid by redirecting fluid flow, which further accelerates particle cooling. Additional turbulence may be provided by accelerating the rate of conditioning fluid provided to the quenching chamber. While the frusto-conical shape of the quenching chamber and high conditioning fluid flow rate provide for some additional turbulence, for smaller and better-controlled nanoparticles produced by a high-throughput system, an ultra-turbulent quenching chamber is desirable. Some embodiments of an ultra-turbulent quenching chamber are provided in U.S. Publication No. 2008/0277267, the contents of which are hereby incorporated by reference in their entirety.

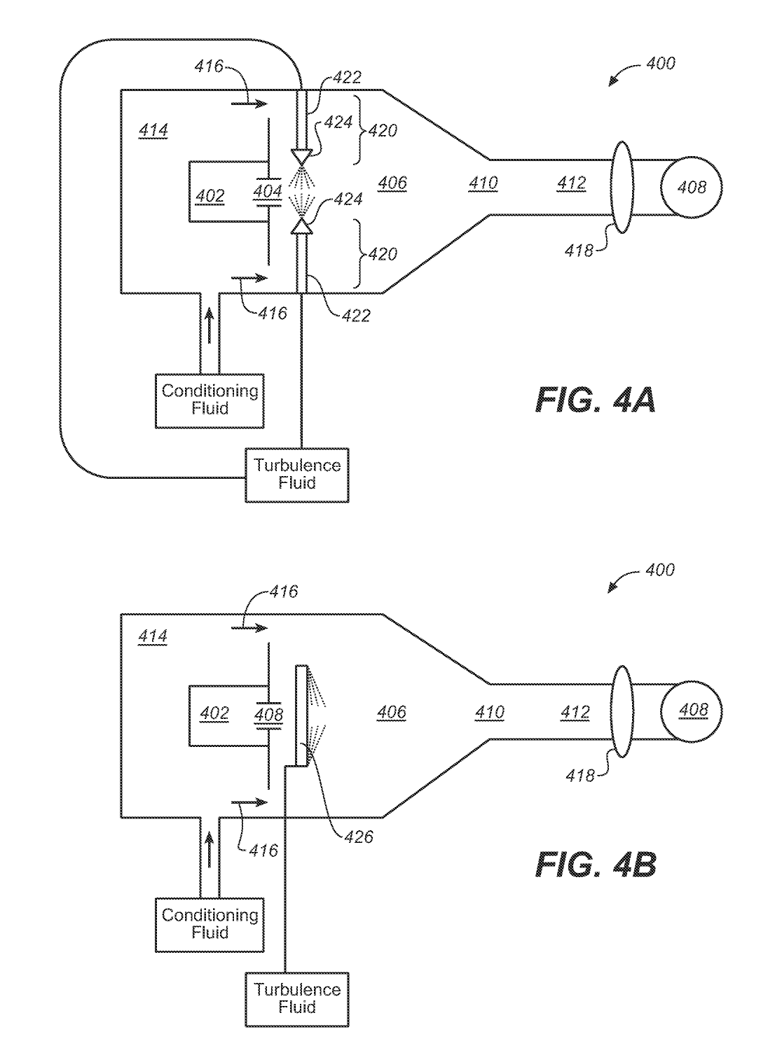

In a high-throughput particle production system, turbulence inducing jets may be provided within the quenching chamber to further increase turbulence and produce an ultra-turbulent quenching chamber. FIG. 4A illustrates one embodiment of the ultra-turbulent quenching chamber using turbulence inducing jets. Upon ejection of the reaction mixture from a plasma gun 402 through a plasma gun outlet 404, the reaction mixture enters the quenching chamber 406. As the hot reaction mixture moves into the quenching chamber 406, it rapidly expands and begins to cool. Newly formed particles agglomerate and grow in size during this cooling process within the quenching chamber until the temperature of the material reaches below a threshold temperature. A pressure gradient within the quenching chamber 406 causes the particles to exit the quenching chamber 406 at a quenching chamber outlet 410 and into a cooling conduit 412. The pressure gradient may be provided by a suction force generator 408 disposed downstream of the quenching chamber. The suction force generator 408 may be, but is not limited to, a vacuum or blower. Alternatively, or in addition to the suction force generator 408, the pressure gradient may be provided by conditioning fluid flowing into the quenching chamber 406 at a higher pressure than it exits through the quenching chamber outlet 410. Conditioning fluid can be provided to a gun box 414, which is fluidly connected to the quenching chamber 406 by one or more ports 416.

To provide additional turbulence and accelerated cooling, one or more turbulence inducing jets 420 inject turbulence fluid into the quenching chamber 406. In some embodiments, the turbulence fluid is of the same type as the conditioning fluid. In some embodiments, the turbulence fluid is argon, but may also be a different inert gas. In some embodiments, multiple turbulence inducing jets 420 are disposed in an annular formation around the plasma gun outlet 404. Preferably, in some embodiments using multiple turbulence inducing jets 420, the turbulence inducing jets 420 are uniformly spaced apart. In some embodiments where multiple turbulence inducing jets 420 are employed, the turbulence inducing jets 420 may be independently supplied with turbulence fluid. In some embodiments, the turbulence inducing jets 420 may be fluidly interconnected with a single turbulence fluid supply. In some embodiments, the turbulence inducing jets 420 are equipped with a tube 422 and a spray nozzle 424. In some embodiments, however, no spray nozzle 424 is provided and turbulence fluid is emitted directly from the tube 422.

Turbulence fluid can be supplied to the turbulence inducing jets 420 at a pressure of 100 to 300 PSI to induce turbulence within the quenching chamber. In some embodiments, turbulence fluid is supplied at a pressure of 200 PSI. In some embodiments, turbulence fluid is supplied at a pressure of 120 PSI. In some embodiments, turbulence fluid is supplied at a pressure of 260 PSI. Preferably, the turbulence generated should be a Reynolds number greater than 1000. The turbulence inducing jets 420 can eject conditioning fluid at 20 to 120 degrees with respect to the flow of the reactive reaction mixture through the plasma gun outlet 404 such that the flow of the conditioning fluid is against the flow of the reactive reaction mixture when the angle is greater than 90 degrees. In some embodiments, the turbulence inducing jets 420 can eject turbulence fluid perpendicular to the flow of the reactive reaction mixture through the plasma gun outlet 404, as illustrated in FIG. 4A. In embodiments with multiple turbulence inducing jets 420, the turbulence inducing jets 420 may be angled away from the center of the annular formation such that no turbulence inducing jet 420 emits turbulence fluid directly towards any other turbulence inducing jet 420. In some embodiments, the turbulence inducing jets 420 are angled 2 to 15 degrees away from the center of the annular formation. In some embodiments, the turbulence inducing jets 420 are angled 12 degrees away from the center of the annular formation. In some embodiments, the turbulence inducing jets 420 are angled 8 degrees away from the center of the annular formation. In some embodiments, the turbulence inducing jets 420 are angled 5 degrees away from the center of the annular formation. In some embodiments, the turbulence inducing jets 420 are angled 2 degrees away from the center of the annular formation.

The turbulence generated by the turbulence inducing jets 420 promotes mixing of the conditioning fluid with the reaction mixture, thereby increasing the quenching rate. The quenching rate may be adjusted by altering the amount of turbulence generated by the turbulence inducing jets 420. For example, the turbulence inducing jets may be angled more perpendicularly to the material flow stream or by increasing the flow rate of conditioning fluid emitted by the turbulence inducing jets.

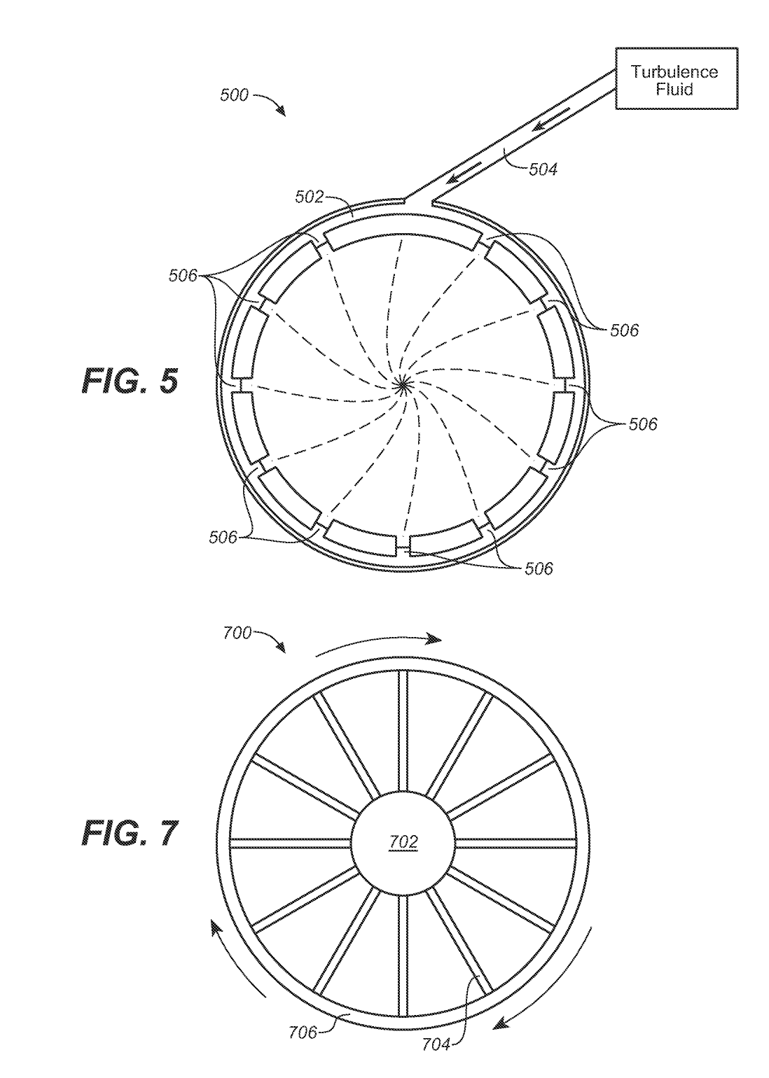

An alternative embodiment of producing increased turbulence within the ultra-turbulent quenching chamber 406 is illustrated in FIGS. 4B and 5. In this embodiment, turbulence inducing jest are interconnected using a ring structure 426 and 500. The ring structure 426 can be disposed within the quenching chamber 406 such that the flow of the reactive material exiting the plasma gun 402 through the plasma gun outlet 404 passes through the ring structure 426. Referring to FIG. 5, the ring structure 500 comprises an inner channel 502 fluidly connected to turbulence fluid supply conduit 504, which can supply turbulence fluid to the ring structure. The inner channel 502 is configured to distribute turbulence fluid approximately evenly throughout the ring structure 500. One or more outlet ports 506 are annularly disposed along the ring structure 500 to release turbulence fluid into the quenching chamber. The outlet ports 506 can eject turbulence fluid at 20 to 120 degrees with respect to the flow of the reactive reaction mixture through the plasma gun outlet 404, such that the flow of the turbulence fluid is against the flow of the reactive reaction mixture when the angle is greater than 90 degrees. In some embodiments, the outlet ports 506 can eject turbulence fluid perpendicular to the flow of the reactive reaction mixture through the plasma gun outlet 404. In embodiments with multiple outlet ports 506, the outlet ports 506 may be angled away from the center of the annular formation such that no outlet ports 506 emits turbulence fluid directly towards any other outlet ports 506. In some embodiments, the outlet ports 506 are angled 2 to 15 degrees away from the center of the annular formation. In some embodiments, the outlet ports 506 are angled about 12 degrees away from the center of the annular formation. In some embodiments, the outlet ports 506 are angled about 8 degrees away from the center of the annular formation. In some embodiments, the outlet ports 506 are angled about 5 degrees away from the center of the annular formation. In some embodiments, the outlet ports 506 are angled about 2 degrees away from the center of the annular formation.

Turbulence fluid can supplied to the outlet ports 506 at a pressure of about 100 to 300 PSI to induce turbulence within the quenching chamber. In some embodiments, turbulence fluid is supplied at a pressure of about 200 PSI. In some embodiments, turbulence fluid is supplied at a pressure of about 120 PSI. In some embodiments, turbulence fluid is supplied at a pressure of about 260 PSI. Preferably, the turbulence generated should be a Reynolds number greater than 1000.

The ultra-turbulent quenching chamber accelerates cooling time of the newly formed particles relative to more typical quenching chambers, resulting in smaller and more controlled particles. An ultra-turbulent quenching chamber is desirable in a high-throughput particle production system to continuously produce optimal and uniformly sized particles.

### Laminar Flow Disruptor in a Cooling Conduit

In typical plasma-based particle production systems, newly formed particles entrained in the conditioning fluid flow from the quenching chamber to a collector via a fluidly connected cooling conduit. Upon expulsion from the quenching chamber, the mixture of particles and conditioning fluid can stabilize into a laminar flow while in a typical cooling conduit even though it may have been turbulent in the quenching chamber. While in the cooling conduit, particles are still warm and can aggregate on the walls of the cooling conduit. After a period of operation of a typical particle production system, buildup of particles along the cooling conduit walls can result in undesirably sized particles or clogging of the cooling conduit. An undesirable system shutdown would therefore be required to manually clean the cooling conduit and return the system to proper function. A continuous high-throughput plasma-based particle production system preferably avoids particle buildup within the cooling conduit.

Buildup of newly formed nanoparticles along the walls of the cooling conduit can be prevented or slowed by providing a laminar flow disruptor within the cooling conduit. The laminar flow disruptor converts laminar flow of the mixture of conditioning fluid and newly formed particles into non-laminar flow. Non-laminar flow redirects the particles, causing entrained particles to collide with particles adhering to the conduit walls. These collisions dislodge the adhered particles from the cooling conduit walls, allowing the dislodge particles to reenter the system flow. This prevents particle buildup within the cooling conduit and obviates the need for a system shut down due to particle buildup within the cooling conduit. The laminar flow disruptor in the cooling conduit is therefore desirable for continuous operation of a high-throughput particle production system with a consistent material throughput.

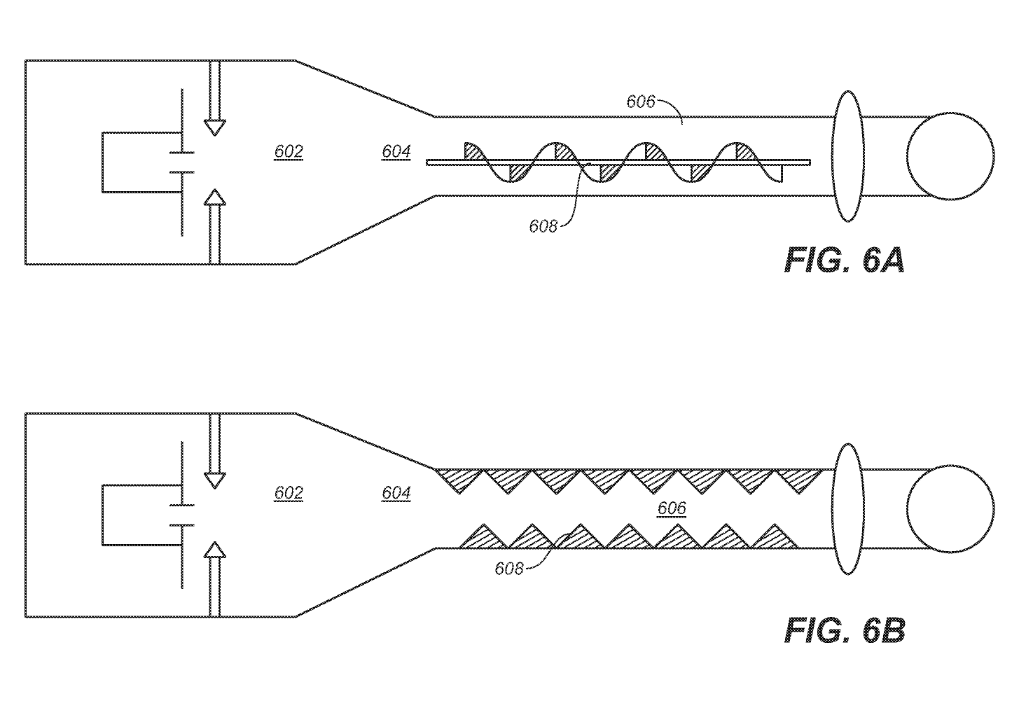

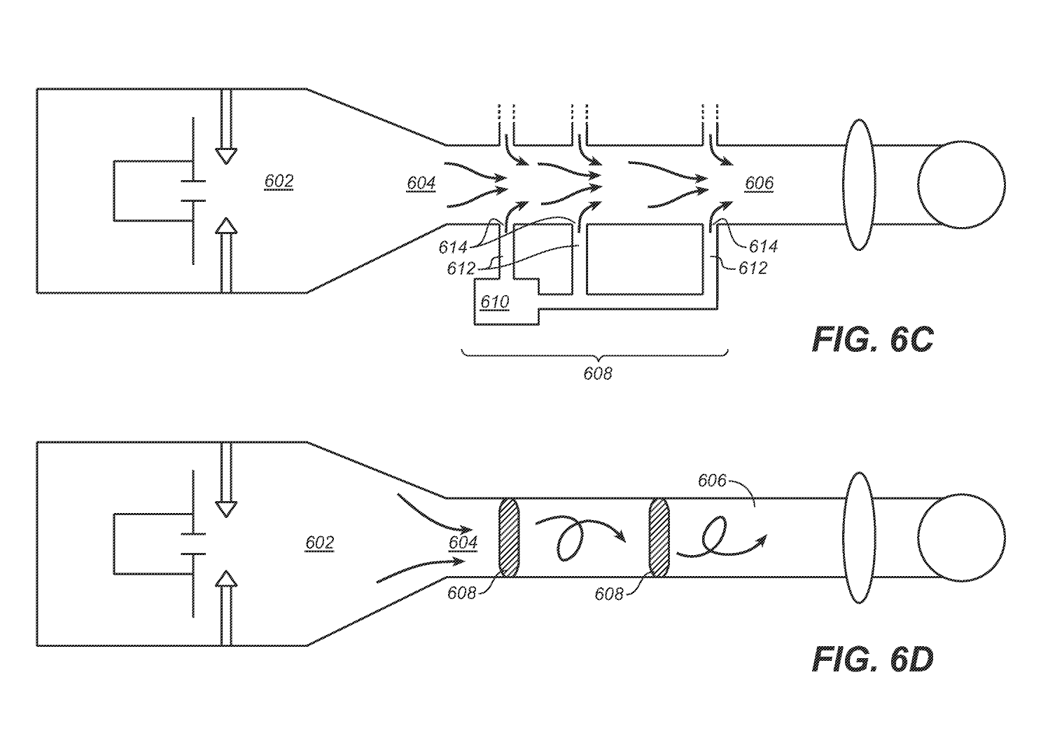

Some embodiments of a laminar flow disruptor are illustrated in FIGS. 6A-D and 7. The combined conditioning fluid, turbulence fluid, and reaction mixture flows from a quenching chamber 602 through a quenching chamber ejection port 604 and into a cooling conduit 606. In some embodiments, a laminar flow disruptor 608 is present within the cooling conduit 606. The laminar flow disruptor 608 may include, but is not limited to, one or more blades, baffles, a helical screw (FIG. 6A), ridges, bumps (FIG. 6B), air jets (FIG. 6C), rotating or stationary axially arranged rods or blades (FIGS. 6D and 7), or other airflow redirecting devices. Some embodiments may use more than one type of laminar flow disruptor. In some embodiments, the laminar flow disruptor 608 may be mobile or rotate. In some embodiments, the laminar flow disruptor 608 is static.

When the laminar flow disruptor 608 is a helical screw, as illustrated in FIG. 6A, the helical screw may extend through the entire length of the cooling conduit 606 or may extend for only a portion of the length of the cooling conduit. When the helical screw only extends for a portion of the length of the cooling conduit, multiple helical screw segments may be used throughout the cooling conduit 606. Each segment of the helical screw preferably completes at least one full turn about a helical axis, however some embodiments of the helical screw form of the laminar flow disruptor 608 need not do so. When a mixture of conditioning fluid and particles enters the cooling conduit 606, laminar flow is disrupted by being redirected by the helical screw, inducing non-laminar flow.

When the laminar flow disruptor 608 is one or more bumps, as illustrated in FIG. 6B, the bumps may be randomly distributed or evenly distributed throughout the cooling conduit. In some embodiments, bumps may be clustered or more concentrated in one section of the cooling conduit 606 than another. When the laminar flow disruptor 608 consists of a series of bumps, the bumps may be, but need not be, adjoining.

When the laminar flow disruptor 608 comprises one or more air jets, as illustrated in FIG. 6C, a laminar flow disruptor fluid source 610 is fluidly connected a supply channel 612, which can inject laminar flow disruptor fluid to the cooling conduit 606 via a laminar flow disruptor fluid injection port 614. Preferably, the laminar flow disruptor fluid is the same type of fluid as the conditioning fluid, but may be any other inert gas. If multiple air jets are used, the laminar flow disruptor fluid injection ports 614 may be annularly disposed and various points along the cooling conduit 606. In some embodiments, the laminar fluid injection ports 614 are directed away from the quenching chamber 602. In some embodiments, the laminar fluid injection ports 614 are directed perpendicular to the walls of the cooling conduit 606 or in the direction of the quenching chamber 602. When the high-throughput particle production system is in operation, the force of laminar flow disruptor fluid injected into the cooling conduit 606 can alter the trajectory of the mixture of conditioning fluid and particles within the cooling conduit 606 and cause non-laminar flow. This non-laminar flow prevents particles from accumulating along the walls of the cooling conduit 606.

When the laminar flow disruptor is embodied by axially arranged bars or blades, as illustrated in FIG. 6D, one or more laminar flow disruptors 608 may be placed within the cooling conduit 606 such that the mixture of conditioning fluid and particles flows between the bars or blades. The blades or bars may rotate so that when the particles entrained by the conditioning fluid pass through the bars or blades a substantially helical vortexing pattern may be generated. If multiple laminar flow disruptors 608 comprising rotating bars or blades, the bars or blades may be rotating in the same direction or different directions. If blades are used, the blades may be in any orientation from perpendicular to parallel to the trajectory of the cooling conduit 606. FIG. 7 illustrates one embodiment of the laminar flow disruptor comprising rotating bars about an axis. In this embodiment, a motor 702 is disposed in the center of the laminar flow disruptor 700. Attached to the motor 702 two or more bars 704 are annularly disposed about and controlled by the motor 702. During operation of the high-throughput particle production system, the motor 702 causes the bars 704 to rotate about a central axis. Optionally, a stabilizing rim 706 may be positioned about the circumference of the laminar flow disruptor 700 to limit displacement of the bars 702. The rotation of the bars 704 can cause rotation of the particles entrained in the conditioning fluid within the cooling conduit 606 generating non-laminar flow. The non-laminar flow can cause the dislodging of particles adhered to the walls of the cooling conduit 606.

The laminar flow disruptor 608 limits particle agglomeration along the walls of the cooling conduit 606 by redirecting the material directional flow within the cooling conduit 606. Some particles may still adhere to the conduit walls; however, the constant flow redirection dislodges adhered particles by causing particles within the gas stream to collide with particles adhering to the walls. The laminar flow disruptor consequentially prevents clogging of the cooling conduit 606, allowing continual material flow by alleviating the need to shut down the high-throughput particle production system to clean the cooling conduit 606. A laminar flow disruptor within the cooling conduit of a high-throughput particle production system is therefore desirable for continuous and consistent operation and material throughput.

The described systems allow the particle production system to operate continuously at a flow rate of at least 9 grams/minute, of at least 30 grams/minute, or of at least 60 grams/minute for at least 6 hours, at least 12 hours, at least 24 hours, at least 48 hours, at least 72 hours (3 days), at least 336 hours (14 days), at least 672 hours (28 days), or at least 1344 hours (56 days), without clogging occurring in the cooling conduit.

### Gas Delivery System With Constant Overpressure

In a typical particle production system, material throughput is generally maintained using a pressure gradient allowing particles to flow from the plasma gun to a collection device. The pressure gradient can be established by applying a suction force downstream of a collection device to generate a negative pressure relative to the upstream plasma gun and quenching chamber. Particles are often collected in the collection device using a filter. During operation of a typical particle production system, however, the filter can become clogged, requiring greater suction force to produce the desired pressure gradient and ensure continuous particle throughput. When the filter is replaced, there is a decreased need for the suction force in order to produce the desired pressure gradient. The suction force can cause the internal pressure of the plasma gun or quenching chamber to fall below the ambient pressure, however, resulting in contamination due to an influx of the ambient gasses during particle formation. The leakage can be alleviated by producing an overpressure relative to the ambient pressure in a gun box surrounding the plasma gun and in the quenching chamber. Too high of an overpressure, however, will result in excessive leakage from the system to the ambient environment, so it is preferred that the overpressure be minimized. Providing a fixed overpressure into the system will not effectively minimize the pressure differential between the system pressure and the ambient pressure due to fluctuations of the suction force. For consistent throughput using a high-throughput particle production system, the pressure differential between the system and the ambient environment is preferably minimized while maintaining a constant overpressure relative to the ambient pressure.

It has been found that an effectively constant system overpressure relative to the ambient pressure can be maintained through the use of a gas supply system with a system overpressure module sensitive to the ambient pressure. The system overpressure generated by the system overpressure module can minimize system leakage and contamination as it is configured to supply conditioning fluid to a gun box at a fixed amount above ambient pressure. In some embodiments, the gas supply system delivers conditioning fluid to both the gun box and the collection system minimally above the ambient pressure but sufficient to maintain a pressure gradient. Alternatively, independent gas supply systems deliver the conditioning fluid to the gun box and collection system. In another alternative, conditioning fluid is supplied only to the gun box and not the collection device. This system allows the high-throughput particle production system to maintain a constant but minimal system overpressure within the gun box and quenching chamber. Preferably, the system maintains an overpressure of at least 1 inch of water above ambient pressure, or at least 2 inches of water above ambient pressure. Preferably, the system maintains an overpressure of less than 10 inches of water above ambient pressure, less than 5 inches of water above ambient pressure, or less than 3 inches of water above ambient pressure.

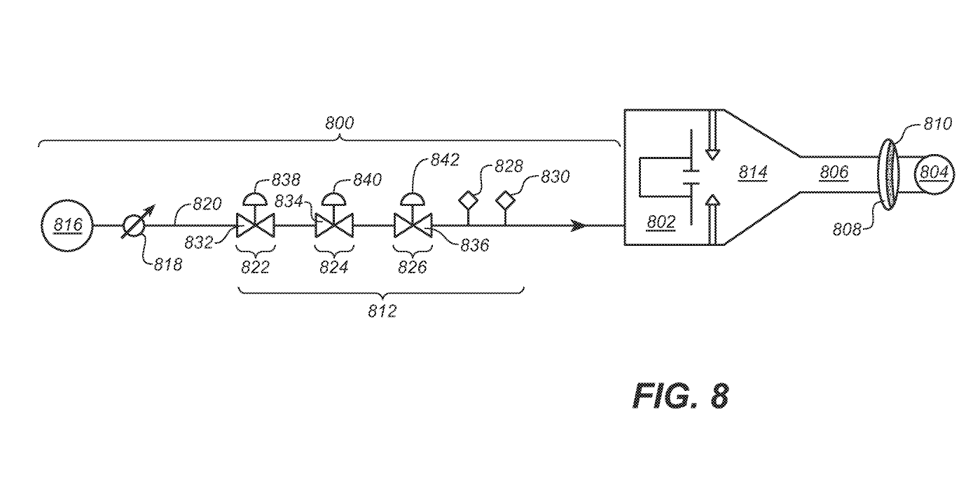

FIG. 8 illustrates one embodiment of a gas delivery system 800 with constant overpressure. A pressure gradient forms when conditioning fluid flows into the gun box 802 and a suction force is applied by a suction force generator 804 downstream of the cooling conduit 806. In some embodiments, the suction force generator 804 is a vacuum pump. In some embodiments, the suction generator 804 is a blower. In some embodiments, the suction generator is provided within a collection device 808. The suction generator 804 pulls the spent conditioning fluid through the collection device 808 and, preferably, through a filter element 810. The filter element 810 is configured to remove remaining particles within the conditioning fluid stream, producing a filtered output. During continuous operation of the high-throughput particle production system, the filter element 810 may become clogged, which may result in the need to increase the suction force. System overpressure can be maintained by utilizing a system overpressure module 812 supplying conditioning fluid to the quenching chamber 814 via the gun box 802.

In one embodiment of the gas delivery system 800, one or more conditioning fluid reservoirs 816 are integrated into the gas supply system and is fluidly connected to the system overpressure module 812. In some embodiments, one or more conditioning fluid supply valves 818 may be optionally placed between any conditioning fluid reservoir 816 and the system overpressure module 812. In an embodiment where more than one conditioning fluid reservoir 816 is used, the fluid type may be of the same type or of different types. In one embodiment, the conditioning fluid reservoir 816 contains argon. Conditioning fluid flows from the conditioning fluid reservoir 816 to the system overpressure module 812 via a conditioning fluid supply conduit 820.

The system overpressure module 812 regulates flow from the conditioning fluid reservoir 816 to the gun box 802. The system overpressure module 812 ensures conditioning fluid is supplied to the gun box 802 at a constant but minimal overpressure relative to the ambient pressure. In some embodiments, the system overpressure module 812 is contained within a single housed unit. In some embodiments, the system overpressure module 812 is not contained within a single housed unit. In some embodiments, the system overpressure module 812 is not housed in any unit, but may instead be a network of conduits, valves, and pressure regulators. The system overpressure module 812 comprises one or more pressure regulators 822, 824, and 826 fluidly coupled in serial formation. In some embodiments, the system overpressure module 812 also comprises one or more pressure relief valves 828 and 830.

In one embodiment of the gas delivery system 800, a conditioning fluid is transported to the system overpressure module 812 via a conditioning fluid supply conduit 820. The conditioning fluid reservoir 816 supplies conditioning fluid to the conditioning fluid supply conduit 820 and system overpressure module 812 at an original pressure P₁ (such as about 250-350 PSI). The system overpressure module 812 reduces the conditioning fluid pressure from an inlet pressure P₁ to an outlet pressure P₄, which is set relative to ambient pressure. In some embodiments, the outlet pressure P₄ is a fixed amount greater than the ambient pressure. In some embodiments, the outlet pressure P₄ has a fixed ratio relative to the ambient pressure. In some embodiments, the system overpressure module 812 supplies conditioning fluid to the gun box 802 at an outlet pressure range of about 1-12 inches of water above ambient. In some embodiments, the system overpressure module 812 supplies conditioning fluid to the gun box 802 at an outlet pressure of about 4 inches of water above ambient. In some embodiments, the system overpressure module 812 supplies conditioning fluid to the gun box 802 at an outlet pressure of about 8 inches of water above ambient. In some embodiments, the system overpressure module 812 supplies conditioning fluid to the gun box 802 at an outlet pressure of about 2 inches of water above ambient. In some embodiments, the system overpressure module 812 supplies conditioning fluid to the gun box 802 at an outlet pressure range of about 1 inch of water above ambient.

In some embodiments, each pressure regulator 822, 824, and 826 comprises a control portion 832, 834, and 836, and a valve portion 838, 840, and 842. In some embodiments, at least one of the pressure regulators uses a diaphragm-based regulation mechanism. Preferably, the diaphragm-based regulation mechanism comprises a diaphragm-based demand valve. Typically, the first serially located pressure regulator 822 receives conditioning fluid from the conditioning fluid supply conduit 820 at P₁. The control portion 838 uses input from P₁ and ambient pressure to control the valve portion 832, releasing the conditioning fluid at an outlet pressure P₂ (such as about 50 PSI above ambient pressure). In some embodiments, a second serially located pressure regulator 824 receives conditioning fluid at P₂. The control portion 840 uses input pressure P₂ and ambient pressure to control the valve portion 834, releasing the conditioning fluid at an outlet pressure P₃ (such as about 2 PSI above ambient pressure). In some embodiments, a third serially located pressure regulator 826 receives conditioning fluid at P₃. The control portion 842 uses input pressure P₃ and ambient pressure to control the valve portion 836, releasing the conditioning fluid at an outlet pressure P₄.

In some embodiments, the system overpressure module 812 may optionally comprise one or more independent pressure relief valves 828 and 830 fluidly coupled between the final pressure regulator 826 and the gun box 802. In some embodiments, the pressure relief valves 828 and 830 are configured to vent gas to the ambient environment if the pressure received is greater than a selected pressure. In some embodiments, the first pressure relief valve 828 receives gas at pressure P₄ from the final serial pressure regulator 826. In some embodiments, if P₄ is above a selected threshold, the pressure relief valve 828 vents gas to the ambient environment, reducing the inlet pressure to the gun box 802. In some embodiments, the selected threshold is relatively high compared to ambient, so that under normal operation the pressure relief valve 828 is not activated. In some embodiments, the system overpressure module 812 comprises a plurality of pressure relief valves 828 and 830 having differing sensitivities and are set at differing thresholds. Preferably, the second serially disposed pressure relief valve 830 has a lower threshold than the first serially disposed pressure relief valve 828.

In a high-throughput particle production system with continual and consistent material throughput, it is desirable to avoid contamination by maintaining the pressure of the plasma gun and quenching chamber minimally above ambient pressure. By configuring a gas delivery system to deliver conditioning fluid to the gun box at a constant overpressure relative to the ambient pressure while reducing the pressure differential between the system and the ambient environment, contamination of the continuously operated high-throughput particle production system will be minimized. This allows consistent material throughput and production of high-quality nanoparticles.

### Conditioning Fluid Purification and Recirculation System

To ensure constant material flow through the nanoparticle production system, a large amount of high purity conditioning fluid may be used. In typical particle production systems, spent conditioning fluid is generally vented into the ambient environment. While this solution may be effective in smaller scale particle production, venting spent conditioning fluid into the ambient environment is not cost-effective or environmentally desirable for a high-throughput particle production system that is kept in continuous operation. Furthermore, venting spent condition fluid may cause particle production slowdowns or stoppages due to frequent replacement of the conditioning fluid supply tanks. Recirculation of the spent conditioning fluid without purification would result in an accumulation of impurities that may be introduced into the particle production system due to leaks in the system, the feed material, or any secondary fluid different from the conditioning fluid (such as working gas or turbulence fluid). Such impurities may include, but are not limited to, reactive oxidizing impurities, hydrogen gas, chloride compounds, or water. A cost-effective high-throughput particle production system recirculates the conditioning fluid while maintaining conditioning fluid purity. This results in less wasted fluid, ensures higher quality particle production, and avoids system shutdown that may result when replacing empty supply tanks.

Conditioning fluid can be recirculated within a high-throughput particle production system to reduce the waste of costly conditioning fluid. It has been found that impurities can also be removed during the recirculation of the conditioning fluid using a conditioning fluid purification system, allowing a consistently pure conditioning fluid to be recirculated back into the system. A conditioning fluid purification and recirculation system can provide a continuously operating high-throughput particle production system with recirculated and purified conditioning fluid, providing a cost-effective solution for continuous operation of a high-throughput particle production system.

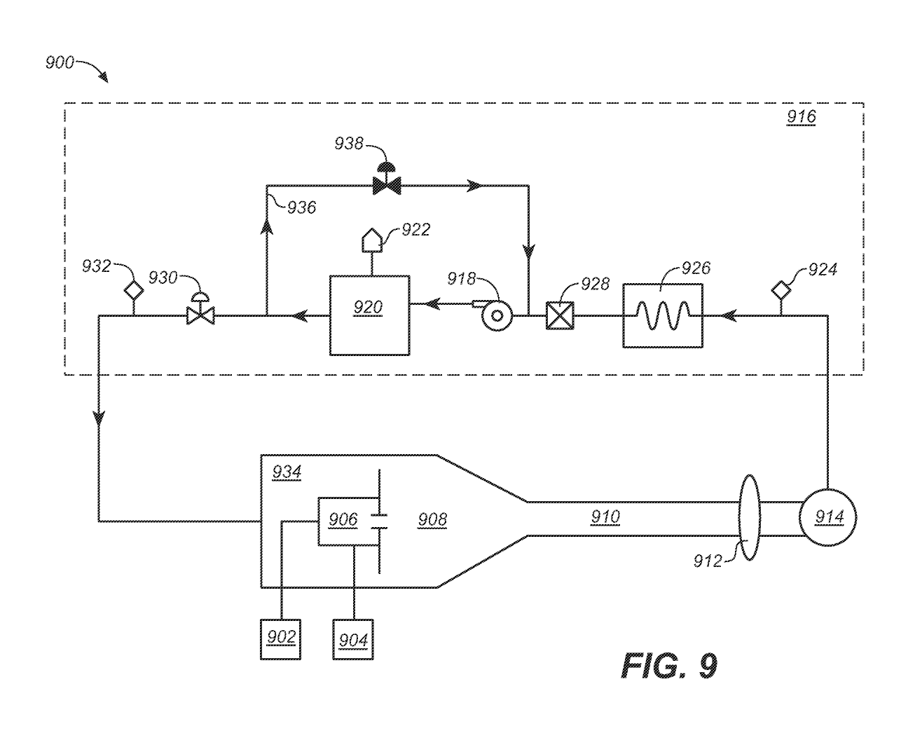

FIG. 9 illustrates one embodiment of a conditioning fluid purification and recirculation system in operation with a high-throughput particle production system. Working gas 902 and feed material 904 are introduced to a plasma gun 906 while the high-throughput particle production system is in operation. The plasma gun 906 generates a plasma and forms a hot reactive mixture with the introduced feed material and working gas before it is expelled into the quenching chamber 908. Once in the quenching chamber 908 the hot reactive mixture is cooled by conditioning fluid. Cooling particles entrained in the conditioning fluid stream pass through a cooling conduit 910 before being collected by a collection device 912. Spent conditioning fluid, along with any impurities, is pulled through the system by a suction force generator 914, such as a vacuum or blower, before being introduced to a conditioning fluid purification system 916.

The conditioning fluid purification system 916 may be any system configured to accept spent conditioning fluid and emit a more purified conditioning fluid. FIG. 9 illustrates one embodiment of a conditioning fluid purification and recirculation system. Upon entry of the spent conditioning fluid into the conditioning fluid purification system 916, a compressor 918 forces spent conditioning fluid into a gas purifier 920. The gas purifier 920 may include any known system of removing impurities from a gas, including, but not limited to, heated or ambient temperature getters, desiccators, gravity separation, hydroxide-based scrubbers, or other chemical catalysts. In some embodiments, removed gaseous impurities may be disposed of in the ambient environment though a relief vent 922. In some embodiments, impurities may be entrapped on a replaceable cartridge.

In some embodiments, a pressure relief valve 924, a temperature control module 926, or a filter 928 may each be optionally disposed and fluidly connected between the suction force generator 914 and the compressor 918. The pressure relief valve 924 may be configured to release spent conditioning fluid into the ambient if the pressure is above a predetermined threshold. The temperature control module 926 is preferably a heat exchanger, and may serve to reduce the temperature of the spent conditioning fluid prior to purification. The filter 928 may be, but is not limited to, a particle filter or chemical filter.

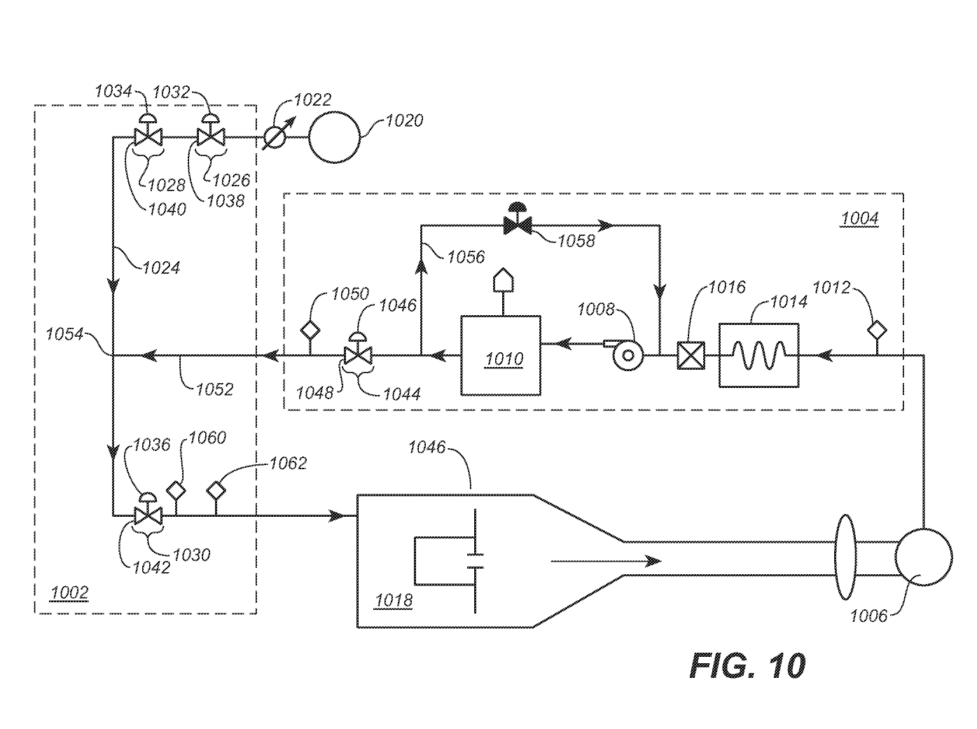

Downstream of the gas purifier 920, one or more pressure regulators 930 may be disposed before the purified conditioning fluid is directed to a gun box 934, completing the recirculation cycle. The pressure regulator 930 may be configured to release purified conditioning fluid at a predetermined outlet pressure. In some embodiments, the outlet pressure of the pressure regulator 930 is a fixed amount greater than the ambient pressure. In some embodiments, the outlet pressure of the pressure regulator 930 has a fixed ratio relative to the ambient pressure. In some embodiments, the pressure regulator 930 releases conditioning fluid at an outlet pressure range of about 1-250 inches of water above ambient. In some embodiments, such as when the conditioning fluid purification system 916 is configured to recirculate purified conditioning fluid directly to the gun box 934 as illustrated in FIG. 9, the pressure regulator 930 may be configured to release purified conditioning fluid at an outlet pressure range of about 1-12 inches of water above ambient. In an alternative embodiment, such as when the conditioning fluid purification and recirculation system 916 is integrated into a system overpressure module (as described below and in FIG. 10), the pressure regulator 930 may be configured to release purified conditioning fluid at an outlet pressure range of about 12-250 inches of water above ambient. In some embodiments, one or more pressure relief valves 932 may be disposed downstream of the pressure regulator 930 and prior to the gun box 934. If present, the pressure relief valve 932 can be configured to release purified conditioning fluid at a predetermined pressure.

In some embodiments, the conditioning fluid purification system 916 may include a backpressure flow loop 936, which may include one or more backpressure regulators 938. The backpressure flow loop diverts some of the purified conditioning fluid from the output of the gas purifier 920 back to the main conduit of the system upstream of the compressor 918. Generally, during operation of the high-throughput particle production system, the backpressure flow loop 936 is inactive. However, pressure may occasionally build within the system, and delivering very high pressures to the gun box 934 may damage sensitive components of the high-throughput particle production system. The pressure may be relieved by venting the purified conditioning fluid into the ambient environment; however avoiding waste of the conditioning fluid is preferred. By diverting some of the conditioning fluid upstream of the compressor where the pressure is generally lower, this conditioning fluid may be salvaged. The backpressure regulator 938 can be configured to activate the backpressure flow loop 936 when the pressure is above a predetermined pressure.

During operation of a high-throughput particle production system, consistent throughput generally depends upon a continuous flow of mostly pure conditioning fluid. Working gas and feed material introduced during the particle production process also frequently introduces impurities which, if allowed to accumulate in the system, may degrade the quality of the produced nanoparticles. Disposing of the spent conditioning fluid would minimize the accumulation of impurities, however is not cost effective for a high-throughput particle production system in continuous operation. A conditioning fluid purification and recirculation system can purify spent conditioning fluid and recirculate it back into the system, allowing for cost-effective continuous use of the high-throughput particle production system. Preferably at least 50, at least 80 wt %, at least 90 wt %, or at least 99 wt % of the conditioning fluid introduced into the nanoparticle production system is purified and recycled.

### Integration of the Gas Delivery System with Constant Overpressure and Conditioning Fluid Purification and Recirculation System

In a preferred embodiment of a high-throughput particle production system, both the gas delivery system with constant overpressure and a condition fluid purification and recirculation system are utilized. Since the output of the gas delivery system and condition fluid purification and recirculation system may have differing pressures, it is preferred that both systems are integrated prior to delivery of the conditioning fluid to the gun box. Through concurrent use of both systems, purified and recirculated conditioning fluid can be provided to the gun box at minimal overpressure relative to the ambient pressure, limiting wasted conditioning fluid, impurities, and system leakage. Furthermore, concurrent use of the gas delivery system and conditioning fluid purification and recirculation system ensures sufficient conditioning fluid will be supplied to the system during continuous use of the high-throughput particle production system even if there is some loss of conditioning fluid during the particle production or recirculation process.

FIG. 10 illustrates one example embodiment of a system overpressure module 1002 integrated with a conditioning fluid purification and recirculation system 1004. In this integrated system, a suction force generator 1006, preferably a vacuum or blower, delivers spent conditioning fluid to the conditioning fluid purification system 1004. Upon entry of the spent conditioning fluid into the fluid purification system 1004, a compressor 1008 forces spent conditioning fluid into a gas purifier 1010. In some embodiments, a pressure relief valve 1012, a temperature control module 1014, or a filter 1016 may each be optionally disposed and fluidly connected between the suction force generator 1006 and the compressor 1008.

The system overpressure module 1002 is configured to deliver conditioning fluid to a gun box 1018 at an outlet pressure P₄, which is set relative to ambient pressure. In some embodiments, the outlet pressure P₄ is a fixed amount greater than the ambient pressure. In some embodiments, the outlet pressure P₄ has a fixed ratio relative to the ambient pressure. In some embodiments, the system overpressure module 1002 supplies conditioning fluid to the gun box 1018 at an outlet pressure range of about 1-12 inches of water above ambient. When the system overpressure module 1002 is integrated with the conditioning fluid purification and recirculation system, the system overpressure module 1002 receives conditioning fluid from two or more sources. In some embodiments, the system overpressure module 1002 receives conditioning fluid from one or more conditioning fluid reservoirs 1020 at a pressure P₁ and from the conditioning fluid purification and recirculation system 1004 at a pressure P₅. In some embodiments, one or more conditioning fluid supply valves 1022 may be optionally placed between any conditioning fluid reservoir 1020 and the system overpressure module 1002.

In some embodiments, the system overpressure module 1002 comprises one or more pressure regulators serially disposed along a conditioning fluid supply conduit 1024. As illustrated in FIG. 10, pressure regulators 1026, 1028, and 1030 each comprise a control portion 1032, 1034, and 1036, and a valve portion 1038, 1040, and 1042. In some embodiments, at least one of the pressure regulators uses a diaphragm-based regulation mechanism. Preferably, the diaphragm-based regulation mechanism comprises a diaphragm-based demand valve. The first serially located pressure regulator 1026 receives the conditioning fluid from one or more conditioning fluid reservoirs 1020 at an initial pressure P₁. The control portion 1032 uses input from P₁ and ambient pressure to control the valve portion 1038, releasing the conditioning fluid at an outlet pressure P₂ (such as approximately 50 PSI above ambient pressure). In some embodiments, a second serially located pressure regulator 1028 receives conditioning fluid at an input pressure P₂. The control portion 1034 uses input pressure P₂ and ambient pressure to control the valve portion 1040, releasing the conditioning fluid at an outlet pressure P₃ (such as approximately 2 PSI above ambient pressure).

Downstream of the gas purifier 1010, one or more pressure regulators 1044 may be disposed between the gas purifier 1010 and the system overpressure module 1002. The pressure regulator 1044 comprises a control portion 1046 and a valve portion 1048. The pressure regulator 1044 may be configured to receive purified conditioning fluid from the gas purifier 1010 and release purified conditioning fluid at a predetermined outlet pressure. The control portion 1046 uses input from the input pressure and the ambient pressure to control the valve portion 1048, releasing the conditioning fluid at an outlet pressure P₅ (such as approximately 100 inches of water above ambient pressure). Optionally, a pressure relief valve 1050 may be disposed downstream of the pressure regulator 1044 and configured to release purified conditioning fluid into the ambient when P₅ is above a predetermined threshold.

The conditioning fluid purification system 1004 releases purified conditioning fluid to the system overpressure module 1002 via a recirculation conduit 1052. The recirculation conduit 1052 connects with the conditioning fluid supply conduit 1024 at a junction 1054. FIG. 10 illustrates the junction 1054 disposed between the second serially disposed pressure regulator 1028 and the third serially disposed pressure regulator 1030, although the junction may be disposed at any position along the conditioning fluid supply conduit 1024. Preferably P₅ is at a pressure higher than the pressure within the conditioning fluid supply conduit 1024 immediately upstream of the junction 1054. For example, as illustrated in FIG. 10, it is preferred that P₅ be greater than P₃.

In the embodiment illustrated in FIG. 10, a third serially disposed pressure regulator 1030 within the system overpressure module 1002 receives conditioning fluid at a pressure dependent upon P₃ and P₅. The control portion 1036 uses the input pressure and ambient pressure to control the valve portion 1042, releasing the conditioning fluid at an outlet pressure P₄.

In some embodiments, the conditioning fluid purification system 1004 may include a backpressure flow loop 1056, which may include one or more backpressure regulators 1058. The backpressure flow loop diverts some of the purified conditioning fluid from the output of the gas purifier 1010 back to the main conduit of the system upstream of the compressor 1008. Generally, during operation of the high-throughput particle production system, the backpressure flow loop 1056 is inactive. The backpressure regulator 1058 can be configured to activate the backpressure flow loop 1056 when the pressure is above a predetermined pressure.

In some embodiments, the system overpressure module 1002 may optionally comprise one or more independent pressure relief valves 1060 and 1062 fluidly coupled between the final pressure regulator 1030 and the gun box 1018. In some embodiments, the pressure relief valves 1060 and 1062 are configured to vent gas to the ambient environment if the pressure received is greater than a selected pressure. In some embodiments, the first pressure relief valve 1060 receives gas at pressure P₄ from the final serial pressure regulator 1030. In some embodiments, if P₄ is above a selected threshold, the pressure relief valve 1060 vents gas to the ambient environment, reducing the inlet pressure to the gun box 1018. In some embodiments, the selected threshold is relatively high compared to ambient, so that under normal operation the pressure relief valve 1060 is not activated. In some embodiments, the system overpressure module 1002 comprises a plurality of pressure relief valves 1060 and 1062 having differing sensitivities and are set at differing thresholds. Preferably, the second serially disposed pressure relief valve 1062 has a lower threshold than the first serially disposed pressure relief valve 1060.

Configured as described, the gas supply system and conditioning fluid purification and recirculation system can be integrated to supply purified conditioning fluid at a constant overpressure relative to the ambient pressure within the gun box, regardless of pressure fluctuations caused by the suction force generator or fluctuations of the ambient pressure. Since a high-throughput particle production system in continuous use utilizes a substantial amount of conditioning fluid, it is preferable to have a system that can purify and recirculate spent condition fluid at a pressure minimally above the ambient pressure.

### Filter Back Pulse

In a typical particle production system, newly produced particles are collected in a collection device by flowing the system output through one or more filter elements. Particles entrained by the spent conditioning fluid are retained by the filter element while spent conditioning fluid passes through the filter element and is exhausted or recirculated. During continuous operation of a high-throughput particle production system, however, the filter element can become clogged with a buildup of newly generated particles. While system operation and material throughput can be maintained for a relatively short period of time by applying an increased suction force downstream of the collection device, a system shutdown is eventually required to collect the particle output and clean and/or replace the filter element.

It has been found that system shutdowns due to clogging filter elements can be minimized in a high-throughput particle production system without disrupting normal system operation and throughput by applying one or more back pulses to the filter, releasing the particles, which may then be collected in a collection vessel. Each back pulse may be created using a burst of fluid, preferably conditioning fluid. This burst may occur for a relatively short time interval and at a high pressure relative to the operating pressure of the collection device. The pressure of each back pulse should be high enough to dislodge particles from the filter element, allowing the particles to fall into a collection vessel. In some embodiments, the back pulses may cause the filter to invert, although inversion of the filter element is not necessary for the invention. The back pulses may be applied manually, at regular intervals, or when a sensor detects a drop in material flow rate or when the suction force necessary to maintain a desired flow rate increases beyond a predetermined threshold value. In some embodiments, the sensor may be a pressure sensor or a flow rate sensor. In some embodiments, a single back pulse may be used, while in other embodiments the back pulses may occur in a series of two or more bursts.

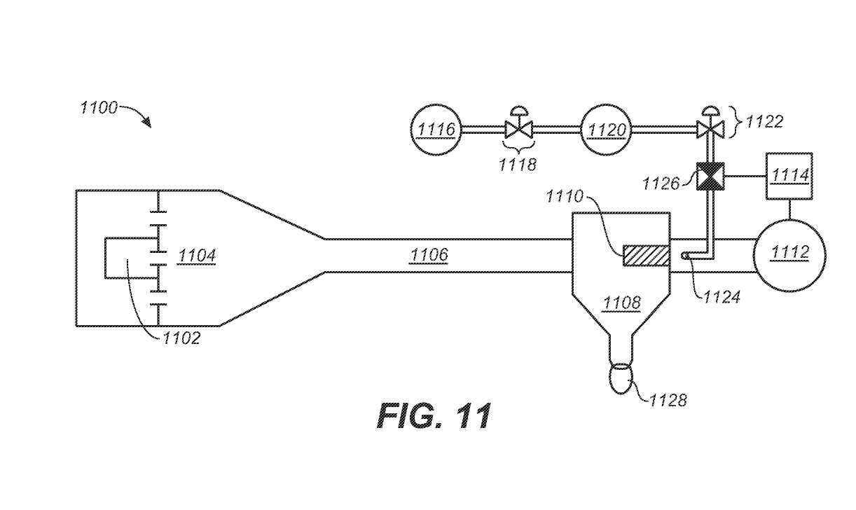

FIG. 11 illustrates one embodiment of a high-throughput particle production system with a filter back pulse system. During particle production, newly generated particles flow from a plasma gun 1102, through a quenching chamber 1104 and cooling conduit 1106, and into a collection device 1108. Spent conditioning fluid can pass through a filter element 1110, the newly produced particles accumulate on the surface of the filter element 1110. In some embodiments a majority or substantially all of the newly produced particles accumulate on the surface of the filter element 1110. Spent conditioning fluid continues to be drawn from the collection device 1108 by a suction force generator 1112 and may be recirculated, vented to the ambient, or otherwise disposed. The suction force generator 1112 may be, for example, a vacuum or a blower. Once particles begin to accumulate on the filter element 1110, the suction force may be continually increased by the suction force generator 1112 to maintain a fixed material flow rate. Since the suction force generator 1112 is unable to perpetually increase the suction force, and because consistent flow rate is desirable, once the material flow rate decreases below a predetermined threshold, for example below 95% of the desired material flow rate, or for example below 90% of the desired material flow rate, or for example below 80% of the desired material flow rate, or the suction force generator 1112 applies a suction force above a predetermined threshold, for example, 95% of capacity, or for example 90% of capacity, or for example 80% of capacity, the filter back pulse system may operate to relieve pressure buildup and restore normal system operation. In some embodiments, a sensor 1114, for example a flow rate sensor or pressure sensor, may be fixed to the suction force generator 1112 to trigger operation of the filter back pulse.

In one embodiment of the filter back pulse system, a back pulse fluid reservoir 1116 is fluidly connected to a first pressure regulator 1118, which is in turn fluidly connected to a back pulse tank 1120. In some embodiments, the back pulse fluid reservoir 1116 contains conditioning fluid, for example argon. The first pressure regulator 1118 is configured to release conditioning fluid to the back pulse tank 1120 at a predetermined pressure such that when the back pulse system is not in operation, the back pulse tank 1120 is pressurized with conditioning fluid at that predetermined pressure. In some embodiments, the first pressure regulator 1118 will release conditioning fluid to the back pulse tank 1120 at about 80 psi to about 140 psi. In some embodiments, the first pressure regulator 1118 will release conditioning fluid to the back pulse tank 1120 at about 100 psi to about 120 psi.

In some embodiments, the back pulse tank 1120 is fluidly connected to a second pressure regulator 1122, which is connected to a back pulse release conduit 1124. The second pressure regulator is configured to release conditioning fluid at a predetermined pressure. In some embodiments, the second pressure regulator 1122 is configured to release conditioning fluid at the same pressure the first pressure regulator 1118 is configured to release conditioning fluid. In other embodiments, the second pressure regulator 1122 is configured to release conditioning fluid at a lower pressure than the first pressure regulator 1118. The back pulse release conduit 1124 is disposed such that conditioning fluid released by the back pulse system is directed towards the filter element 1110 in the opposite trajectory as spent conditioning fluid flow during normal system operation.

In some embodiments, a 2-way direct-acting solenoid valve 1126 is disposed along the back pulse release conduit 1124. The 2-way direct-acting solenoid valve 1126 can act as a trigger mechanism for the filter back pulse system. Upon receiving a signal to engage operation of the filter back pulse system, for example a manual signal or a signal from the sensor 1114, the 2-way direct acting solenoid valve 1126 can release conditioning fluid from the pressurized back pulse tank 1120 to the back pulse release conduit 1124, where it can be delivered to the filter element 1110. In some embodiments, the 2-way direct-acting solenoid valve 1126 releases a single pulse of conditioning fluid. In other embodiments, the 2-way direct-acting solenoid valve 1126 can release a series of two or more pulses. Pulse length can be any length of time, but are typically about 0.1 seconds to about 0.5 seconds in length. When the 2-way direct-acting solenoid valve 1126 releases a series of two or more pulses, there is typically a delay of about 0.1 seconds to about 0.5 seconds between pulses.

Once the back pulse system is employed, particles that accumulated on the surface of the filter element 1110 are dislodged. Typically, the dislodged particles fall into a collection vessel 1128 and can be retained. The unclogged filter element 1110 can then continue to be used without requiring a shutdown of the high-throughput particle production system. The described systems allow the particle production system to operate continuously at a flow rate of at least 9 grams/minute, of at least 30 grams/minute, or of at least 60 grams/minute for at least 6 hours, at least 12 hours, at least 24 hours, at least 48 hours, at least 72 hours (3 days), at least 336 hours (14 days), at least 672 hours (28 days), or at least 1344 hours (56 days), without the need to replace the filter element 1110 within the collection device 1108.

Features and preferences described above in relation to “embodiments” are distinct preferences and are not limited only to that particular embodiment; they may be freely combined with features from other embodiments, where technically feasible, and may form preferred combinations of features.

The description is presented to enable one of ordinary skill in the art to make and use the invention and is provided in the context of a patent application and its requirements. Various modifications to the described embodiments will be readily apparent to those persons skilled in the art and the generic principles herein may be applied to other embodiments. Thus, the present invention is not intended to be limited to the embodiment shown but is to be accorded the widest scope consistent with the principles and features described herein. Finally, the entire disclosure of the patents and publications referred in this application are hereby incorporated herein by reference.

What is claimed is:

1. A nanoparticle production system comprising:
a plasma gun comprising a male electrode, a female electrodes and a working gas supply configured to deliver a working gas in a vortexing helical flow direction across a plasma generation region formed between the male electrode and the female electrode;
a continuous feed systems configured to feed material into the plasma gun at a rate of at least 9 grams/minute;
a quench chamber positioned after the plasma gun and including at least one reaction mixture input and at least one conditioning fluid input;
a cooling conduit configured to conduct nanoparticles entrained in a conditioning fluid flow from the quench chamber to a collector, wherein the cooling conduit comprises a laminar flow disruptor;
a system overpressure module that maintains a pressure in the system above a measured ambient pressure; and
a conditioning fluid purification and recirculation system.

2. The nanoparticle production system of claim 1, wherein the continuous feed system comprises a reciprocating member to continually clear out a material feed supply channel during operation of the nanoparticle production system.

3. The nanoparticle production system of claim 2, wherein the reciprocating member reciprocates at a rate of at least 2 times per second.

4. The nanoparticle production system of claim 1, wherein the continuous feed system comprises a pulsing gas jet to continually clear out a material feed supply channel during operation of the nanoparticle production system.

5. The nanoparticle production system of claim 1, wherein the nano-production system is able to operate for at least 336 hrs without replacement of the male electrode or female electrode.

6. The nanoparticle production system of claim 1, wherein the quench chamber has a frusto-conical shape and is configured to create a turbulence with a Reynolds number of greater than 1000 during operation.

7. The nanoparticle production system of claim 1, wherein the laminar flow disruptor comprises blades, baffles, a helical screw, ridges, or bumps.

8. The nanoparticle production system of claim 1, wherein the particle production system is configured to operate continuously for at least 336 hrs without clogging occurring in the cooling conduit.

9. The nanoparticle production system of claim 1, wherein the pressure in the system is maintained at a pressure of at least 1 inch of water above the measured ambient pressure.

10. The nanoparticle production system of claim 1, wherein at least 80% of the conditioning fluid introduced into the nanoparticle production system is purified and recirculated.

11. A nanoparticle production system comprising:
a plasma gun comprising a male electrode, a female electrodes and a working gas supply configured to deliver a working gas in a vortexing helical flow direction across a plasma generation region formed between the male electrode and the female electrode;
a continuous feed systems configured to feed material into the plasma gun at a rate of at least 9 grams/minute;
a quench chamber positioned after the plasma gun and including at least one reaction mixture input and at least one conditioning fluid input;
a cooling conduit configured to conduct nanoparticles entrained in a conditioning fluid flow from the quench chamber to a collector, wherein the cooling conduit comprises a laminar flow disruptor;
a system overpressure module that maintains a pressure in the system above a measured ambient pressure;
a particle collection device comprising a filter and a pump configured to apply a suction force to the filter so that the conditioning fluid is drawn through the filter and nanoparticles collect on a surface of the filter during operation of the nanoparticle production system;
a back pulse system configured to apply one or more back pulses to the filter during operation of the nanoparticle production system to release nanoparticles collected on the surface of the filter; and
a conditioning fluid purification and recirculation system.

12. The nanoparticle production system of claim 11, wherein the continuous feed system comprises a reciprocating member to continually clear out a material feed supply channel during operation of the nanoparticle production system.

13. The nanoparticle production system of claim 12, wherein the reciprocating member reciprocates at a rate of at least 2 times per second.

14. The nanoparticle production system of claim 11, wherein the continuous feed system comprises a pulsing gas jet to continually clear out a material feed supply channel during operation of the nanoparticle production system.

15. The nanoparticle production system of claim 11, wherein the nano-production system is able to operate for at least 336 hrs without replacement of the male electrode or female electrode.

16. The nanoparticle production system of claim 11, wherein the quench chamber has a frusto-conical shape and is configured to create a turbulence with a Reynolds number of greater than 1000 during operation.

17. The nanoparticle production system of claim 11, wherein the laminar flow disruptor comprises blades, baffles, a helical screw, ridges, or bumps.

18. The nanoparticle production system of claim 11, wherein the particle production system is configured to operate continuously for at least 336 hrs without clogging occurring in the cooling conduit.

19. The nanoparticle production system of claim 11, wherein the pressure in the system is maintained at a pressure of at least 1 inch of water above the measured ambient pressure.

20. The nanoparticle production system of claim 11, wherein at least 80% of the conditioning fluid introduced into the nanoparticle production system is purified and recirculated.

21. The nanoparticle production system of claim 11, wherein the plasma gun comprises a cooling ring annularly disposed about an outlet of the plasma gun.

22. The nanoparticle production system of claim 12, wherein the plasma gun comprises a faceplate that is disposed on an exterior surface of the plasma gun and joined to the cooling ring.

23. The nanoparticle production system of claim 22, wherein the faceplate is kept below 900° C., during continuous operation of the plasma gun for more than 160 hrs.

24. The nanoparticle production system of claim 11, wherein the continuous feed system comprises a plurality of material injection ports have a minimum diameter of at least 1 mm.

25. The nanoparticle production system of claim 11, wherein the male electrode or female electrode is tungsten lined.

26. The nanoparticle production system of claim 11, wherein the average dwell time of particles in the plasma gun is at least 3 msec.

27. The nanoparticle production system of claim 11, wherein the back pulse system is configured to automatically apply one or more back pulses to the filter when a sensor detects a drop in material flow below a predetermined threshold value.

28. The nanoparticle production system of claim 11, wherein the back pulse system is configured to automatically apply one or more back pulses to the filter when a suction force through the filter increases above a predetermined threshold value.

29. The nanoparticle production system of claim 11, wherein the back pulse system is configured to apply one or more back pulses with a pressure of 100 psi to 120 psi.

30. The nanoparticle production system of claim 11, wherein the back pulse system is configured to apply one or more back pulses comprising argon.

31. A plasma gun useful for producing nanoparticles comprising:
a male electrode and a female electrode, wherein either the male electrode or the female electrode comprises a conductive heat resistant metal;
a working gas supply configured to deliver a working gas in a vortexing helical flow direction across a plasma generation region formed between the male electrode and the female electrode; and
a faceplate that is disposed on an exterior surface of the plasma gun separated from a cooling ring.

32. The plasma gun of claim 31, wherein the average dwell time of particles in the plasma gun is at least 3 msec.

33. The plasma gun of claim 31, wherein the male electrode or the female electrode is tungsten lined.

34. The plasma gun of claim 31, wherein the faceplate is kept below 900° C., during continuous operation of the plasma gun for more than 160 hrs.

35. A nanoparticle production system comprising a plasma gun of any one of claims 31-34.

36. A nanoparticle production system comprising:
a plasma gun; and
a continuous feed systems configured to feed material into the plasma gun at a rate of at least 9 grams/minute.

37. The nanoparticle production system of claim 36, wherein the continuous feed system is configured to feed material to the plasma gun for at least 336 hours without clogging.

38. The nanoparticle production system of claim 36, wherein the continuous feed system comprises multiple material feed supply channels to supply feed material to the plasma gun.

39. The nanoparticle production system of claim 36, wherein the continuous feed system comprises a reciprocating member to continually clear out a material feed supply channel during operation of the nanoparticle production system.

40. The nanoparticle production system of claim 39, wherein the reciprocating member reciprocates at a rate of at least 2 times per second.

41. The nanoparticle production system of claim 36, wherein the continuous feed system comprises a pulsing gas jet to continually clear out a material feed supply channel during operation of the nanoparticle production system.

42. The nanoparticle production system of claim 36, wherein the plasma gun comprises a cooling ring annularly disposed about an outlet of the plasma gun.

43. The nanoparticle production system of claim 42, wherein the plasma gun comprises a faceplate that is disposed on an exterior surface of the plasma gun and joined to the cooling ring.

44. The nanoparticle production system of claim 43, wherein the faceplate is kept below 900° C., during continuous operation of the plasma gun for more than 160 hrs.

45. The nanoparticle production system of claim 36, wherein the plasma gun further comprises a plurality of material injection ports having a minimum diameter of at least 1 mm.

46. The nanoparticle production system of claim 36, wherein the average dwell time of particles in the plasma gun is at least 3 msec.

47. The nanoparticle production system of claim 36, further comprising a particle collection device positioned after the plasma gun to separate nanoparticles produced by the plasma gun from a conditioning fluid.

48. The nanoparticle production system of claim 47, wherein the particle production device comprises a filter and a pump configured to apply a suction force to the filter so that the conditioning fluid is drawn through the filter and nanoparticles collect on a surface of the filter during operation of the nanoparticle production system.

49. The nanoparticle production system of claim 48, wherein the particle production device further comprises a back pulse system configured to apply one or more back pulses to the filter during operation of the nanoparticle production system to release nanoparticles collected on the surface of the filter.

50. The nanoparticle production system of claim 49, wherein the back pulse system is configured to automatically apply one or more back pulses to the filter when a sensor detects a drop in material flow below a predetermined threshold value.

51. The nanoparticle production system of claim 49, wherein the back pulse system is configured to automatically apply one or more back pulses to the filter when a suction force through the filter increases above a predetermined threshold value.

52. The nanoparticle production system of claim 49, wherein the back pulse system is configured to apply one or more back pulses with a pressure of 100 psi to 120 psi.

53. The nanoparticle production system of claim 49, wherein the back pulse system is configured to apply one or more back pulses comprising argon.

54. The nanoparticle production system of claim 36, wherein the plasma gun comprises a male electrode, a female electrode and a working gas supply configured to deliver a working gas in a vortexing helical flow direction across a plasma generation region formed between the male electrode and the female electrode.

55. The nanoparticle production system of claim 54, wherein the male electrode or female electrode is tungsten lined.

56. The nanoparticle production system of claim 54, wherein the working gas supply comprises an injection ring positioned before the plasma generation region to create the vortexing helical flow direction.

57. The nanoparticle production system of claim 56, wherein the injection ring comprises a plurality of injection ports.

58. The nanoparticle production system of claim 57, wherein the injection ports are disposed in an annular formation around the male electrode.

59. The nanoparticle production system of claim 58, wherein the injection ports are angled toward the male electrode.

60. The nanoparticle production system of claim 58, wherein the injection ports are angled away from the male electrode.

61. The nanoparticle production system of claim 54, wherein the nano-production system is able to operate for at least 336 hrs without replacement of the male electrode or female electrode.

62. The nanoparticle production system of claim 36, further comprising a quench chamber positioned after the plasma gun and including at least one reaction mixture input and at least one conditioning fluid input.

63. The nanoparticle production system of claim 62, wherein the quench chamber has a frusto-conical shape and is configured to create a turbulence with a Reynolds number of greater than 1000 during operation.

64. The nanoparticle production system of claim 54, further comprising a quench chamber positioned after the plasma gun and including at least one reaction mixture input and at least one conditioning fluid input.

65. The nanoparticle production system of claim 64, wherein the quench chamber has a frusto-conical shape and is configured to create a turbulence with a Reynolds number of greater than 1000 during operation.

66. The nanoparticle production system of claim 62, further comprising a cooling conduit configured to conduct nanoparticles entrained in a conditioning fluid flow from the quench chamber to a collector.

67. The nanoparticle production system of claim 66, wherein the cooling conduit comprises a laminar flow disruptor.

68. The nanoparticle production system of claim 67, wherein the laminar flow disruptor comprises blades, baffles, a helical screw, ridges, or bumps.

69. The nanoparticle production system of claim 67, wherein the particle production system is configured to operate continuously for at least 6 hrs without clogging occurring in the cooling conduit.

70. The nanoparticle production system of claim 64, further comprising a cooling conduit configured to conduct nanoparticles entrained in a conditioning fluid flow from the quench chamber to a collector.

71. The nanoparticle production system of claim 70, wherein the cooling conduit comprises a laminar flow disruptor.

72. The nanoparticle production system of claim 71, wherein the laminar flow disruptor comprises blades, baffles, a helical screw, ridges, or bumps.

73. The nanoparticle production system of claim 71, wherein the particle production system is configured to operate continuously for at least 336 hrs without clogging occurring in the cooling conduit.

74. The nanoparticle production system of claim 36, further comprising a system overpressure module that maintains a pressure in the system above a measured ambient pressure.

75. The nanoparticle production system of claim 74, wherein the pressure in the system is maintained at a pressure of at least 1 inch of water above the measured ambient pressure.

76. The nanoparticle production system of claim 54, further comprising a system overpressure module that maintains a pressure in the system above a measured ambient pressure.

77. The nanoparticle production system of claim 62, further comprising a system overpressure module that maintains a pressure in the system above a measured ambient pressure.

78. The nanoparticle production system of claim 67, further comprising a system overpressure module that maintains a pressure in the system above a measured ambient pressure.

79. The nanoparticle production system of claim 76, further comprising a conditioning fluid purification and recirculation system.

80. The nanoparticle production system of claim 79, wherein at least 80% of the conditioning fluid introduced into the nanoparticle production system is purified and recirculated.

81. A method of continuously feeding input material into a nanoparticle production system comprising:
feeding input material into a plasma gun through a first replaceable material supply tube;
feeding input material into the plasma gun through a second replaceable material supply tube after a decreased flow rate of input material through the first replaceable material supply tube;
stopping flow of input material through the first replaceable material supply tube; and
cleaning or replacing the first replaceable material supply tube, followed by reinitiating input material flow into the plasma gun through the first replaceable material supply tube.

82. A method of continuously feeding input material into a nanoparticle production system comprising:
feeding input material into a plasma gun through a material feed supply channel; and
continuously clearing material feed supply channel by forcing feed material into the plasma gun at a rate of at least 9 grams/minute.

83. The method of claim 81, wherein feed material is forced into the plasma gun by inserting a reciprocating member into the material feed supply channel.

84. The method of claim 82, wherein the reciprocating member reciprocates at a rate of at least 2 times per second.

85. The method of claim 81, wherein feed material is forced into the plasma gun by pulsing gas into the material feed supply channel.

86. A nanoparticle production system comprising:
a plasma gun;
a quench chamber positioned after the plasma gun and including at least one turbulent fluid input; and
a cooling conduit configured to conduct nanoparticles entrained in a conditioning fluid flow from the quench chamber to a collector, wherein the cooling conduit comprises a laminar flow disruptor and the nanoparticle production system is configured to operate continuously for at least 6 hrs without clogging.

87. The nanoparticle production system of claim 86, wherein the quench chamber has a frusto-conical shape and is configured to create a turbulence with a Reynolds number of greater than 1000 during operation.

88. The nanoparticle production system of claim 86, wherein the laminar flow disruptor comprises blades, baffles, a helical screw, ridges, or bumps.

89. The nanoparticle production system of claim 86, wherein the particle production system is configured to operate continuously for at least 336 hrs without clogging occurring in the cooling conduit.

90. The nanoparticle production system of claim 86, wherein the turbulence fluid inputs are annularly disposed about a reaction mixture input.

91. The nanoparticle production system of claim 90, wherein one or more turbulence fluid inputs is a turbulence inducing jet.

92. The nanoparticle production system of claim 91, wherein the turbulence inducing jet is directed towards a reaction mixture input.

93. The nanoparticle production system of claim 91, wherein the turbulence inducing jet is directed away from a reaction mixture input.

94. The nanoparticle production system of claim 91, wherein the turbulence inducing jet is directed perpendicular a reaction mixture input.

95. The nanoparticle production system of claim 90, wherein the turbulence fluid inputs form an interconnected ring.

96. A nanoparticle production system comprising:
a plasma gun;
a particle collection device comprising a filter and a pump configured to apply a suction force to the filter so that the conditioning fluid is drawn through the filter and nanoparticles collect on a surface of the filter during operation of the nanoparticle production system; and
a back pulse system configured to apply one or more back pulses to the filter during operation of the nanoparticle production system to release nanoparticles collected on the surface of the filter.

97. The nanoparticle production system of claim 96, wherein the back pulse system is configured to automatically apply one or more back pulses to the filter when a sensor detects a drop in material flow below a predetermined threshold value.

98. The nanoparticle production system of claim 96, wherein the back pulse system is configured to automatically apply one or more back pulses to the filter when a suction force through the filter increases above a predetermined threshold value.

99. The nanoparticle production system of claim 96, wherein the back pulse system is configured to apply one or more back pulses with a pressure of 100 psi to 120 psi.

100. The nanoparticle production system of claim 96, wherein the back pulse system is configured to apply one or more back pulses comprising argon.

101. The nanoparticle production system of claim 96, wherein the nanoparticle production system is configured to operate for at least 6 hrs without replacement of the filter.

102. The nanoparticle production system of claim 96, further comprising a system overpressure module that maintains a pressure in the system above a measured ambient pressure.

103. The nanoparticle production system of claim 102, wherein the pressure in the system is maintained at a pressure of at least 1 inch of water above the measured ambient pressure.

104. The nanoparticle production system of claim 96, further comprising a conditioning fluid purification and recirculation system.

105. The nanoparticle production system of claim 104, wherein at least 80% of the conditioning fluid introduced into the nanoparticle production system is purified and recirculated.

106. A nanoparticle production system comprising:
a plasma gun;
a system overpressure module that maintains a pressure in the system above a measured ambient pressure;
a conditioning fluid purification and recirculation system;
a particle collection device comprising a filter and a pump configured to apply a suction force to the filter so that the conditioning fluid is drawn through the filter and nanoparticles collect on a surface of the filter during operation of the nanoparticle production system; and
a back pulse system configured to apply one or more back pulses to the filter during operation of the nanoparticle production system to release nanoparticles collected on the surface of the filter.

107. The nanoparticle production system of claim 106, wherein the back pulse system is configured to automatically apply one or more back pulses to the filter when a sensor detects a drop in material flow below a predetermined threshold value.

108. The nanoparticle production system of claim 106, wherein the back pulse system is configured to automatically apply one or more back pulses to the filter when a suction force through the filter increases above a predetermined threshold value.

109. The nanoparticle production system of claim 106, wherein the back pulse system is configured to apply one or more back pulses with a pressure of 100 psi to 120 psi.

110. The nanoparticle production system of claim 106, wherein the back pulse system is configured to apply one or more back pulses comprising argon.

111. The nanoparticle production system of claim 106, wherein the nanoparticle production system is configured to operate for at least 6 hrs without replacement of the filter.
